(19) United States
(12) Patent Application Publication
(10) Pub. No.: US 2011/0263198 A1
(43) Pub. Date: Oct. 27, 2011

(54) RADIO COMMUNICATION SYSTEM, BASE STATION, RELAY STATION, AND MOBILE STATION

(75) Inventors: Jianming WU, Kawasaki (JP); Mitsuhiro AZUMA, Kawasaki (JP); Tomohiko TANIGUCHI, Kawasaki (JP)

(73) Assignee: FUJITSU LIMITED, Kawasaki-shi (JP)

(21) Appl. No.: 13/179,903

(22) Filed: Jul. 11, 2011

Related U.S. Application Data
(63) Continuation of application No. PCT/JP2009/000135, filed on Jan. 15, 2009.

(51) Int. Cl. H04W 40/00; H04B 3/36

(52) U.S. Cl. 455/7

(57) ABSTRACT

A radio communication system includes a base station, a mobile station, and a relay station which is provided for each sector, and divides an assigned band into a plurality of sub-bands for use. A different sub-band is used for each sector for a first communication link. A sub-band different from the sub-band in the first communication link is used for each sector for a second communication link. When a mobile station is located in a first zone, substantially the same sub-band as the second communication link is used in each sector for a third communication link. When a mobile station is located in a second zone farther from the base station than the first zone, a sub-band different from those of the first communication link and the second communication link is used for a fourth communication link. Thus, the interference among the communication links can be suppressed.

### CROSS-REFERENCE TO RELATED APPLICATION

This application is a continuation application of International Application No. PCT/JP2009/000135, which was filed on Jan. 15, 2009, now pending, the contents of which are herein wholly incorporated by reference.

### FIELD

The embodiments discussed herein are related to a radio communication system including a relay station for relaying radio communications between a base station and a mobile station.

### BACKGROUND

Although it is assumed that a high frequency band is assigned in a next generation radio communication system in which a 100M through 1G bit high-speed transmission is requested, a high frequency band signal generally has higher rectilinearity than a low frequency band signal and frequently generates a dead zone where radio waves cannot reach. Therefore, when it is assumed that the transmission power of the base station is identical to that in the currently commercialized radio communication system, the coverage of cells (service area) decreases by assigning a high frequency band. It is not preferable not only in a rising cost by the increase of base stations, but also in a frequent generation of handover.

Under the circumstances, a radio communication system having a relay station for relaying radio communications between a base station and a mobile station has been proposed. Since a relay station generally requires a lower cost than a base station, the entire system can be realized at a lower cost while maintaining sufficient coverage by the implementation of a relay station. A radio communication system provided with a relay station has been surveyed especially in the task group of IEEE802.16j. The items about the above-mentioned IEEE802.16 are described in, for example, IEEE Std 802.16TM-2004, and IEEE Std 802.16eTM-2005.

### SUMMARY

According to an aspect of the invention, a radio communication system has a base station, a mobile station, and a relay station which is provided for each sector, and relays communications between the base station and the mobile station, dividing an assigned band into a plurality of sub-bands for use. In the radio communication system, a different sub-band is used for each sector for a first communication link of the base station and the relay station. A sub-band different from the sub-band in the first communication link is used for each sector for a second communication link of the relay station and the mobile station. When the mobile station is located in a first zone in a range of a specific range from the base station, a substantially same sub-band as the second communication link is used in each sector for a third communication link of the mobile station and the base station. When the mobile station is located in a second zone farther from the base station than the first zone, a sub-band different from those of the first communication link and the second communication link is used for a fourth communication link of the mobile station and the base station.

According to another aspect of the invention, a base station belongs to a radio communication system configured to divide an assigned band into a plurality of sub-bands for use, and performs a radio communication between a mobile station and a relay station provided for each sector configured to relay a communication with the mobile station. It is preset in the radio communication system so that a different sub-band is used for each sector for the first communication link between the base station and the relay station, and a sub-band different from the sub-band for the first communication link is used for each sector for the second communication link between the relay station and the mobile station. The base station includes a position detection unit configured to detect whether the mobile station is located in a first zone in a range at a specific distance from the base station or in a second zone farther from the base station than the first zone, a first communication unit configured to use a substantially identical sub-band with the second communication link in each sector for a third communication link with the mobile station when the position detection unit detects that the mobile station is located in the first zone, and a second communication unit configured to use a sub-band different from sub-bands of the first communication link and the second communication link for a fourth communication link between the mobile station and the base station when the position detection unit detects that the mobile station is located in the second zone.

According to another aspect of the invention, a relay station belongs to a radio communication system configured to divide an assigned band into a plurality of sub-bands for use, and relays a radio communication between a base station and a mobile station. In the radio communication system, a setting is performed in advance so that a difference sub-band is to be used for each sector for a first communication link between the base station and the relay station. The relay station includes a third communication unit configured to use a different sub-band from the sub-band of the first communication link for each sector for the first communication link between the relay station and the mobile station. The sub-band used by the third communication unit is substantially identical to the sub-band used in the third communication link between the base station and the mobile station located in a first zone in a range at a specific distance from the base station, and is different from the sub-band used in the fourth communication link between the base station and the mobile station located in the second zone farther from the base station than the first zone.

According to another aspect of the invention, a mobile station belongs to a radio communication system configured to divide an assigned band into a plurality of sub-bands for use, and performs a radio communication between a base station and a relay station provided for each sector and configured to relay a communication with the base station. In the radio communication system, it is set in advance so that a different sub-band is to be used for each sector for a first communication link between the base station and the relay station. The mobile station includes a fourth communication unit configured to use a sub-band different from a sub-band for the first communication link for each sector for the second communication link between the relay station and the mobile station, a fifth communication unit configured to use a substantially identical sub-band with the second communication link for each sector for a third communication link used between the mobile station and the base station when the local mobile station is located in a first zone in a range at a specific distance from the base station, and a sixth communication unit configured to use a different sub-band from sub-bands of the first communication link and the second communication link for a fourth communication link used between the mobile station and the base station when the mobile station is located in a second zone farther from the base station than the first zone.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory view of the configuration in cell units of the radio communication system according to the first embodiment;

FIG. 2 illustrates the multi cell environment of the radio communication system according to the first embodiment;

FIG. 3 illustrates a mode of the interference between adjacent cells in the radio communication system according to the first embodiment;

FIG. 4 illustrates the level of the interference between adjacent cells as a simulation result in the radio communication system according to the first embodiment;

FIG. 5 illustrates a mode of the interference between adjacent cells in the radio communication system according to the first embodiment;

FIG. 6 illustrates the level of the interference between adjacent cells as a simulation result in the radio communication system according to the first embodiment;

FIG. 7 illustrates a mode of the interference between the communications from a base station (BS) and a relay station (RS) to a mobile station;

FIG. 8 illustrates a simulation result of a communication link from a BS to a mobile station (MS) in the radio communication system according to the first embodiment;

FIG. 9 illustrates a simulation result of a communication link from an RS to an MS in the radio communication system according to the first embodiment;

FIG. 10 illustrates a simulation result of a communication link between a BS and an MS, and between an RS and an MS in the radio communication system according to the first embodiment;

FIG. 11 is a schematic diagram of a sub-band used in each communication link in the radio communication system according to the second embodiment;

FIG. 12 illustrates a sub-band used in each communication link for the bandwidth assigned to the radio communication system according to the second embodiment;

FIG. 13 is an explanatory view of the coverage by each communication link in the radio communication system according to the second embodiment;

FIG. 14 is an example of a block diagram of an important part of the internal configuration of a base station (BS);

FIG. 15 is an example of a block diagram of an important part of the internal configuration of a relay station (RS);

FIG. 16 is an example of a block diagram of an important part of the internal configuration of a mobile station (MS);

FIG. 17 is an explanatory view of the preferable transmission power of a BS and/or RS in the radio communication system according to the second embodiment;

FIG. 18 is a view of the frequency reuse state of the radio communication system according to the first embodiment;

FIG. 19 illustrates a performance evaluation result of the radio communication system according to the second embodiment;

FIG. 20 illustrates a performance evaluation result of the radio communication system according to the second embodiment;

FIG. 21 illustrates a performance evaluation result of the radio communication system according to the second embodiment;

FIG. 22 illustrates a performance evaluation result of the radio communication system according to the second embodiment;

FIG. 23 illustrates a performance evaluation result of the radio communication system according to the second embodiment; and

FIG. 24 illustrates a performance evaluation result of the radio communication system according to the second embodiment.

### DESCRIPTION OF EMBODIMENTS

In the entire description below, a base station, a relay station, and a mobile station are appropriately abbreviated as a BS, an RS, and an MS respectively. Furthermore, when each of a specific base station, a specific relay station, and a specific mobile station is specified and described, a reference numeral is added after each of the characters BS, RS, and MS.

1. Radio Communication System According to the First Embodiment (Relay System)

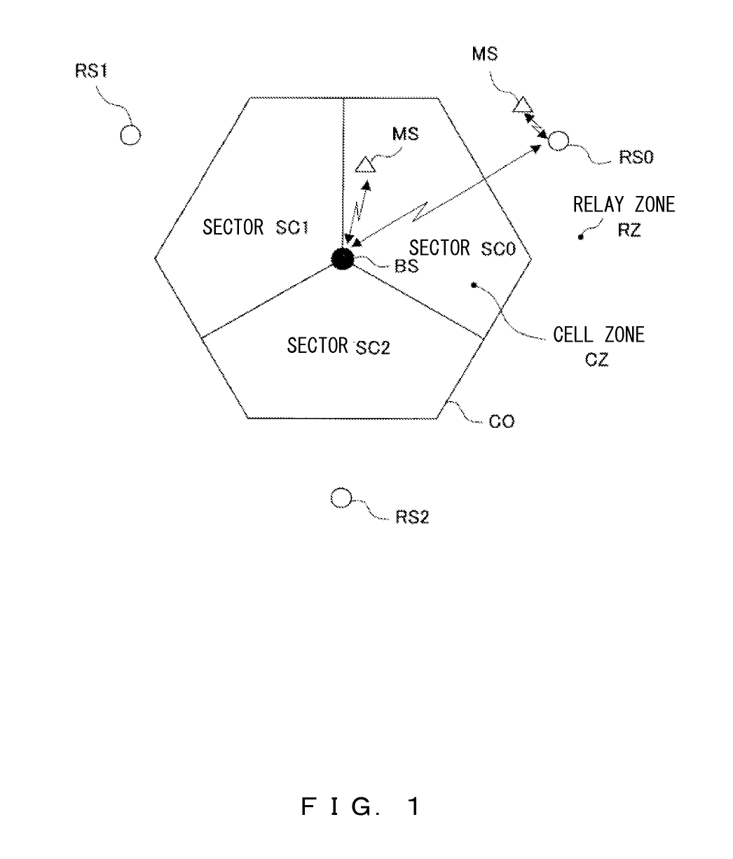

First, an example of the configurations the configuration in cell units of the radio communication system according to the present embodiment is described with reference to FIG. 1. with reference to FIG. 1, a cell is an area (service area) in which a BS and an MS can directly communicate with each other. In this area, a cell is configured by three sectors SC0 through SC2. Outside the cell, RS0 through RS2 are provided for sectors SC0 through SC2 respectively. Each relay station is provided with an omnidirectional antenna.

In the description below, an area in a cell is defined as a cell zone CZ. An area outside the cell zone CZ in which any RS can perform radio communications with an MS is defined as a relay zone RZ.

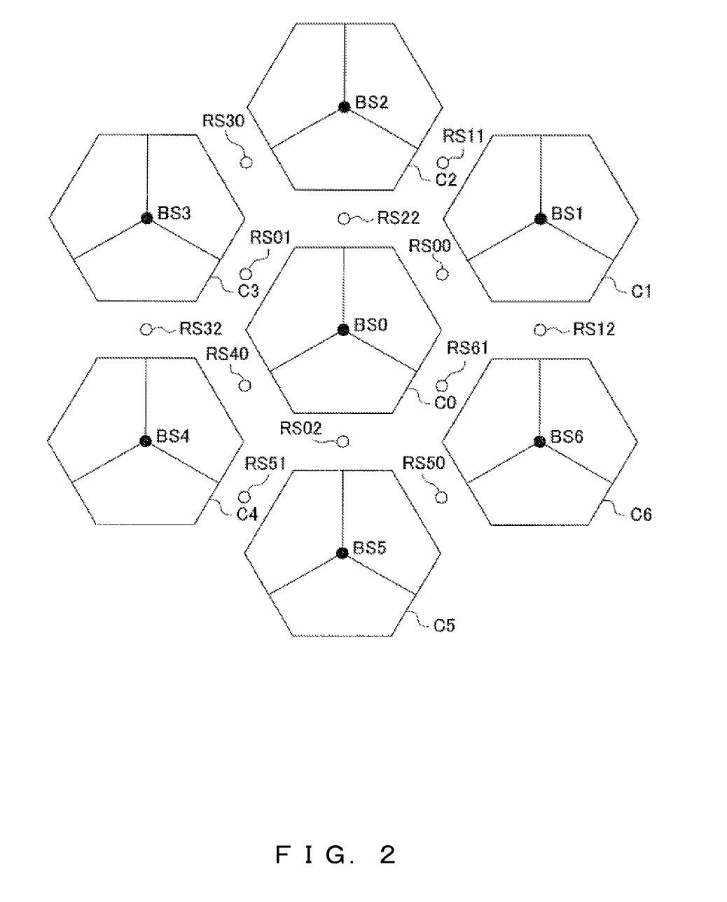

Next, an example of the configurations of a plurality of cells of the radio communication system according to the present embodiment is described with reference to FIG. 2. FIG. 2 illustrates the multicell environment of the radio communication system according to the present embodiment.

FIG. 2 illustrates a cell C0 and a plurality of cells C1 through C6 adjacent to the cell C0. The cells C1 through C6 are service areas of base stations BS1 through BS6 respectively. A relay station RSij (where j=0˜2 and each corresponds to sectors SC0 through SC2 respectively) subordinate to a base station BSi (i=1, 2, . . . ) relays the radio communications between the BS and the MS located in the relay zone.

The radio communication system according to the present embodiment, the frequency reuse rate is 1, that is, the same band is used for the communication link of the BS and the RS, the same band is used for the communication link of the BS and the MS, and the same band is used for the RS and the MS.

2. Interference in the Radio Communication System According to the First Embodiment

Next, the interference according to the three following modes among a plurality of communication links assumed in the radio communication system (relay system) of the first embodiment is described below in order.

(2-1) Interference by the Communication Link Between an Adjacent BS and its Subordinate RS

(2-2) Interference by the Communication Link Between the RS Subordinate to the Adjacent BS and the MS

(2-3) Interference Between the Communication Link from the BS to the MS and the Communication Link from the RS Subordinate to the BS to the MS

(2-1) Interference by the Communication Link Between an Adjacent BS and its Subordinate RS

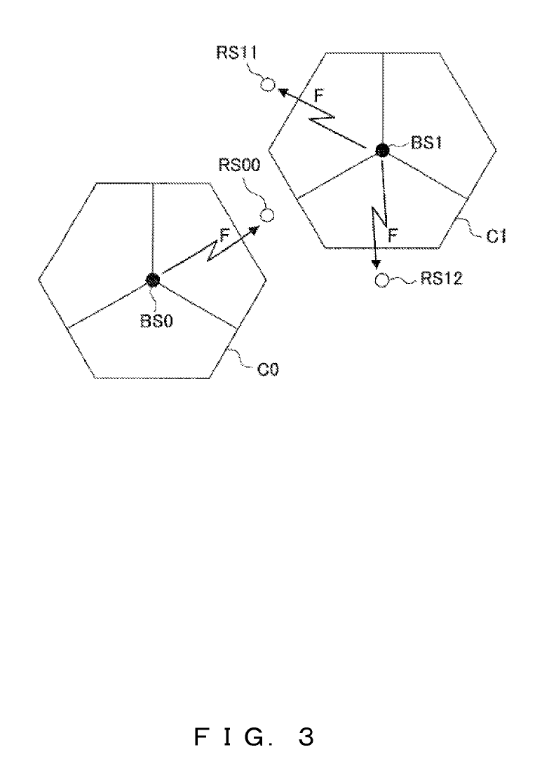

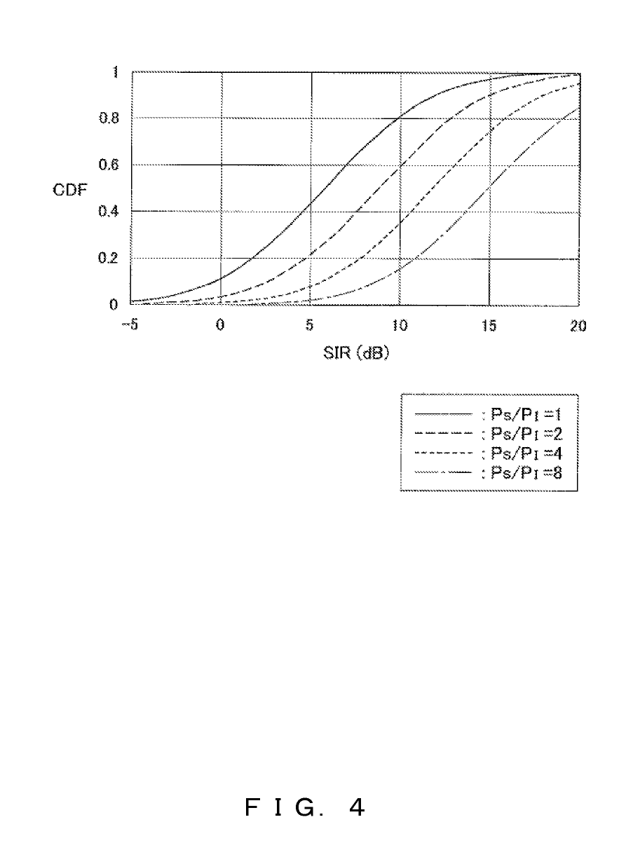

First, the interference received by the communication between a BS and its subordinate RS from the communication between an adjacent BS and its subordinate RS is described below with reference to FIGS. 3 and 4.

FIG. 3 illustrates a mode of the interference between adjacent cells in the relay system. FIG. 4 illustrates the level of the interference between adjacent cells as a simulation result of the CDF (cumulative density function) of the signal-to-interference ratio (SIR).

In FIG. 3, as a typical case, a downlink (band F) from a BS0 (cell C0) to its subordinate RS00, and a downlink (band F) from the adjacent BS1 (cell C1) to its subordinates RS11 and RS12 are assumed.

In the communication state illustrated in FIG. 3, if interference is dominant over noise, the signal-to-interference ratio SIR_{BS0-RS00-BS1} of the signal received by the RS00 from the BS0 to the interference by the BS1 can be represented by the following equation 1 or 2. In the equations 1 and 2, the transmission power of the BS0 and the BS1 is defined as P_{S} and P_{I} respectively, and the transmission antenna gains of the BS0 and the BS1 are defined as G_{S}, G_{I} respectively. β_{S}, β_{I} are assumed to be shadowing attenuations (random variables statistically independent of each other).

$$\begin{matrix}S I {R}_{BS 0 - RS 00 - BS 1} = \frac{{P}_{S} {G}_{S}}{2 {P}_{I} {G}_{I}} \cdot {10}^{\frac{{β}_{S} - {β}_{I}}{10}} ( linear scale ) & ( equation 1 ) \\ {SIR}_{BS 0 - RS 00 - BS 1} = 10 {log}_{10} ( \frac{{P}_{S} {G}_{S}}{2 {P}_{I} {G}_{I}} ) + ( {β}_{S} - {β}_{I} ) ( dB scale ) & ( equation 2 )\end{matrix}$$

Assuming that the shadowing attenuations β_{S}, β_{I} are in accordance with the normal distribution and the standard deviations are σ_{S}, σ_{I} respectively, the value p (βΔ) as the PDF (probability density function) of βΔ(=β_{S}−β_{I}) is generally defined by the following equation 3. Furthermore, if the equation 2 is substituted into the equation 3, the value F (SIR_{BS0-RS00-BS1}) as the CDF of SIR_{BS0-RS00-RS12} can be represented by the following equation 4 where the function erf can be obtained by the following equation 5.

$$\begin{matrix}p ( {β}_{Δ} ) = \frac{1}{\sqrt{2 π ( {σ}_{S}^{2} + {σ}_{I}^{2} )}} exp ( - \frac{{β}_{Δ}^{2}}{2 ( {σ}_{S}^{2} + {σ}_{I}^{2} )} ) & ( equation 3 ) \\ F ( {SIR}_{BS 0 - RS 00 - BS 1} ) = \frac{1}{2} + \frac{1}{2} erf ( \frac{{SIR}_{BS 0 - RS 00 - BS 1} - 10 {log}_{10} ( \frac{{P}_{S} {G}_{S}}{2 {P}_{I} {G}_{I}} )}{\sqrt{2 ( {σ}_{S}^{2} + {σ}_{I}^{2} )}} ) & ( equation 4 ) \\ erf ( x ) = \frac{2}{\sqrt{π}} {\int }_{0}^{x} {e}^{- {t}^{2}} d t & ( equation 5 )\end{matrix}$$

In the equation 4 above, assuming that σ_{S}=σ_{I}=4.3 as an example and the transmission power ratio P_{S}/P_{I} is changed in the range of 1 through 8, the result (simulation result) of the CDF of the SIR is illustrated in FIG. 4. In FIG. 4, the SIR with P_{S}/P_{I}=8 indicates that it excels that with P_{S}/P_{I}=1 (that is, in FIG. 4, the line closer to the right end indicates a more preferable SIR). For example, the probability that the SIR is equal to or smaller than 5 dB is 0.42, 0.21, 0.08, and 0.02 respectively with P_{S}/P_{I}=1, 2, 4, and 8, and the higher the transmission power ratio P_{S}/P_{I} is, the lower the probability becomes.

What is understood with reference to 4 is that, in the relay system, the interference received by the communication between the BS0 and its subordinate RS from the communication between the adjacent BS1 and its subordinate RS cannot be ignored under the condition that the transmission power of the BS0 is equivalent to the transmission power of the BS1.

(2-2) Interference by the Communication Link Between the RS Subordinate to the Adjacent BS and the MS

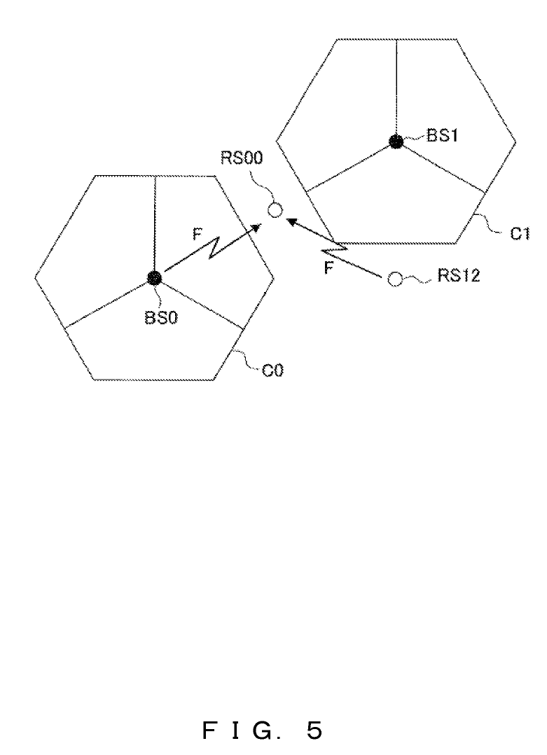

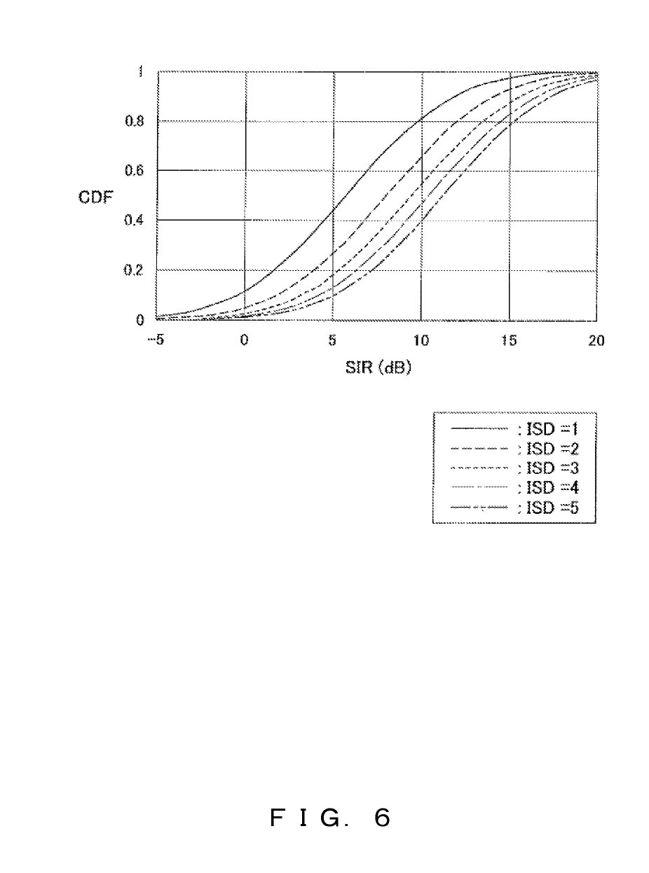

Next, the level of the interference received by the communication between a BS and its subordinate RS from the communication between the RS subordinate to the adjacent BS and the MS is described below with reference to FIGS. 5 and 6.

FIG. 5 illustrates a mode of the interference between adjacent cells in the relay system. FIG. 6 illustrates the level of the interference between adjacent cells as a simulation result of the CDF of the SIR. In FIG. 5, as a typical case, a downlink (band F) from a BS0 (cell C0) to its subordinate RS00, and a downlink (band F) from the RS12 (or RS11) of the adjacent BS1 (cell C1) to the MS are assumed.

In the communication state illustrated in FIG. 5, if interference is dominant over noise, the signal-to-interference ratio SIR_{BS0-RS00-BS12} of the signal received by the RS00 from the BS0 to the interference by the RS12 can be represented by the following equation 6. In the equation 6, the transmission power of the BS0 and the RS12 is defined as P_{S} and P_{I} respectively, and the transmission antenna gains of the BS0 and the RS12 are defined as G_{S}, G_{I} respectively. β_{S}, β_{I} are assumed to be shadowing attenuations (random variables statistically independent of each other).

In this example, assume that the path losses (radio wave attenuations depending on the distance from the source) between the BS0 and the RS00 and between the RS12 and the RS00 are respectively L_{BS0-BS00}, L_{RS00-RS12}. The following equations 7 and 8 are examples of representing L_{BS0-BS00}, L_{RS00-RS12} where d indicates the distance (km) between the source and the destination.

$$\begin{matrix}{SIR}_{BS 0 - RS 00 - RS 12} = 10 {log}_{10} ( \frac{{P}_{S} {G}_{S}}{{P}_{I} {G}_{I}} ) + ( {L}_{RS 00 - RS 12} - {L}_{BS 0 - RS 00} ) + ( {β}_{S} - {β}_{I} ) ( dB scale ) & ( equation 6 ) \\ {L}_{BS 0 - RS 00} = 105.13 + 40.65 {log}_{10} ( d ) & ( equation 7 ) \\ {L}_{RS 00 - RS 12} = 113.10 + 48.58 {log}_{10} ( d ) & ( equation 8 )\end{matrix}$$

When the equation 6 is substituted into the equation 3, the value F (SIR_{BS0-RS00-RS12}) as the CDF of SIR_{BS0-RS00-RS12} can be represented by the following equation 9.

$$F ( {SIR}_{BS 0 - RS 00 - RS 12} ) = \frac{1}{2} + \frac{1}{2} erf ( \frac{\begin{matrix}{SIR}_{BS 0 - RS 00 - RS 12} - 10 {log}_{10} ( \frac{{P}_{S} {G}_{S}}{{P}_{I} {G}_{I}} ) - \\ ( {L}_{RS 00 - RS 12} - {L}_{BS 0 - RS 00} )\end{matrix}}{\sqrt{2 ( {σ}_{S}^{2} + {σ}_{I}^{2} )}} ) \qquad ( equation 9 )$$

In the equation 9 above, FIG. 6 illustrates a result (simulation result) of the CDF of the SIR when the inter-site distance (ISD) is changed in the range of 1 through 5 (km) with, for example, σ_{S}=σ_{I}=4.3. As illustrated in FIG. 6, it is natural that the SIR is improved with a longer ISD. However, when the ISD is a short distance of 1˜2 km, the interference by the adjacent RS12 is concerned. Nevertheless, when the ISD is a short distance a sufficiently SIR can be acquired although there is no relay station. Therefore, based on the relay system, an ISD longer than 1˜2 km can be assumed. Under the distance, it is understood that the performance degradation by interference is hardly detected.

(2-3) Interference Between the Communication Link from the BS to the MS and the Communication Link from the RS Subordinate to the BS to the MS

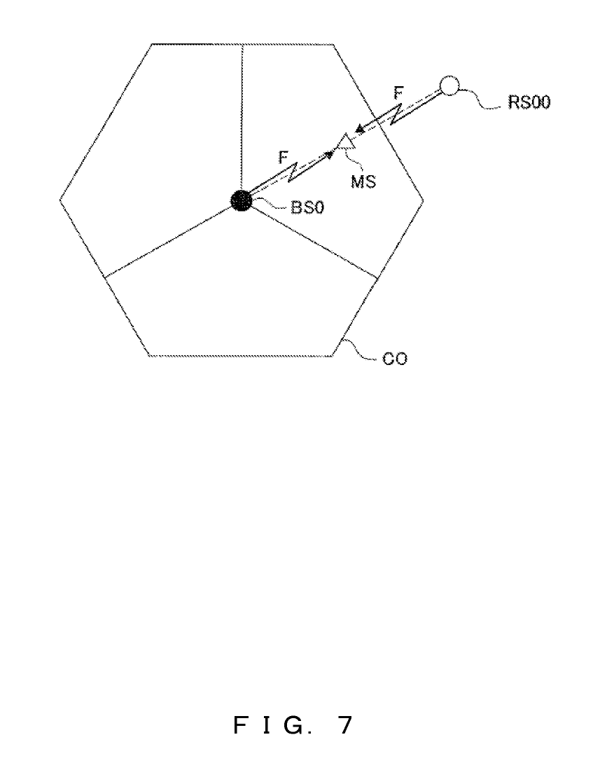

Next, level of the interference between the communication from the BS to the MS, and the communication from the RS subordinate to the BS to the MS is described below with reference to FIGS. 7 through 10.

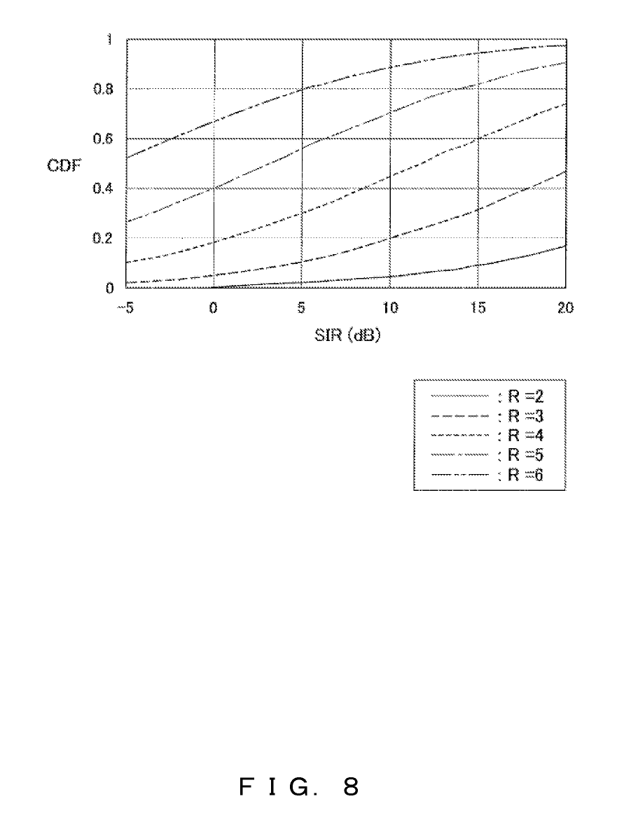

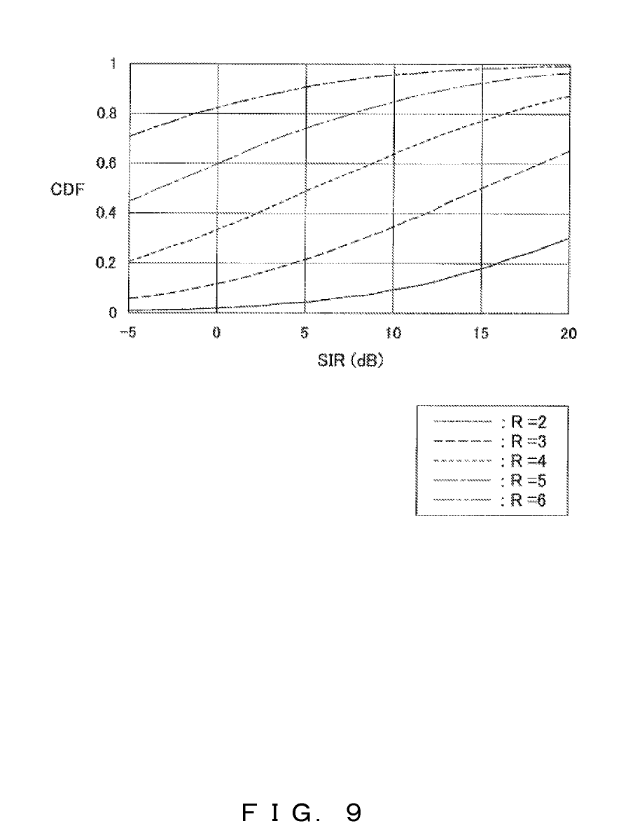

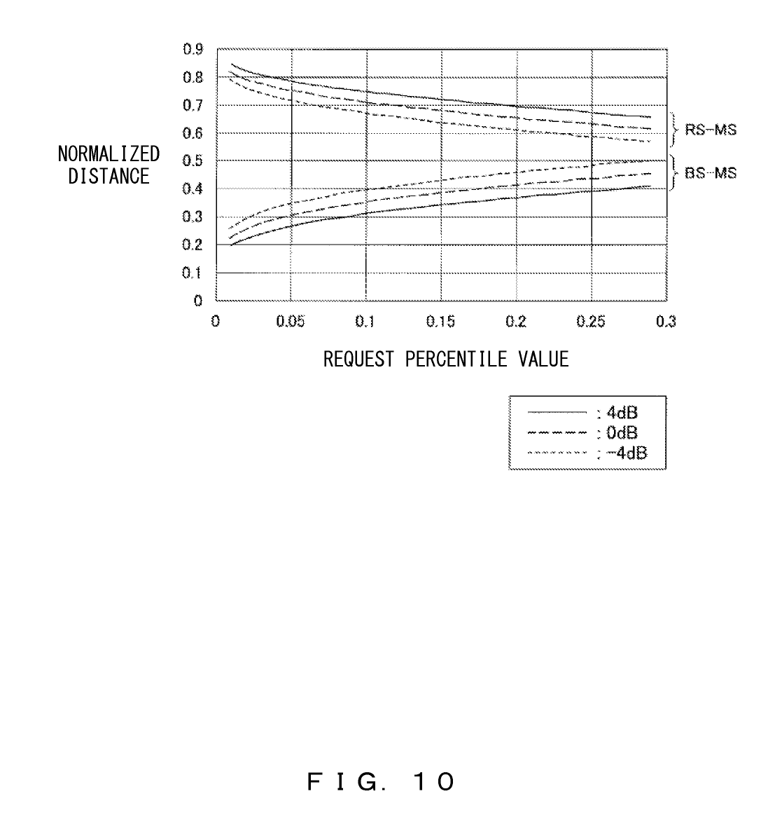

FIG. 7 illustrates a mode of the interference between the communications from a BS and an RS to an MS. FIG. 8 illustrates a simulation result of the CDF of the SIR of a communication link from a BS to an MS. FIG. 9 illustrates a simulation result of the CDF of the SIR of a communication link from an RS to an MS. FIG. 10 illustrates a request percentile value of the SIR for guarantee that the SIR is equal to or exceeds a specific value with respect to the communication link between a BS and an MS, and between an RS and an MS using the relationship with the position of the MS.

In FIG. 7, as a typical case, the downlink (band F) from the BS0 (cell C0) to the MS and the downlink (band F) from the RS00 subordinate to the BS0 to the MS are assumed. That is, the case in which the same band is reused between the BS and its subordinate RS is assumed.

In addition, as the worst case from the viewpoint of the interference in which the MS moves on the line between the BS0 and the RS00 is assumed, and the fluctuation of the SIR of the signal from the BS0 and the RS00 depending on the position of the MS is described below.

In the communication state illustrated in FIG. 7, if the interference is dominant over the noise, the signal-to-interference ratio SIR_{BS-MS-RS} of the signal received by the MS from the BS0 to the interference by the RS00 can be represented by the equation 10 below. In the equation 10, the transmission power of the BS0 and the RS00 is defined respectively as P_{S}, P_{I} and the transmission antenna gains of the BS0 and the RS00 are defined as G_{S}, G_{I} respectively. The β_{S}, β_{I} are shadowing attenuations (random variables statistically independent of each other).

In addition, in this example, the path losses between the BS0 and the MS and between the RS00 and the MS are defined as L_{BS-MS}, L_{RS-MS} respectively. The following equations 11 and 12 are examples of representing L_{BS-MS}, L_{RS-MS} respectively when d indicates the distance (km) between the source and the destination.

$$\begin{matrix}{SIR}_{BS - MS - RS} = 10 {log}_{10} ( \frac{{P}_{S} {G}_{S}}{{P}_{I} {G}_{I}} ) + ( {L}_{RS - MS} - {L}_{BS - MS} ) + ( {β}_{S} - {β}_{I} ) ( dB scale ) & ( equation 10 ) \\ {L}_{BS - MS} = 126.0 + 47.5 {log}_{10} ( d ) & ( equation 11 ) \\ {L}_{RS - MS} = 128.9 + 50.4 {log}_{10} ( d ) & ( equation 12 )\end{matrix}$$

When the equation 10 is substituted into the equation 3, the value F (SIR_{BS-MS-RS}) as the CDF of the SIR_{BS-MS-RS} can be represented by the following equation 13.

$$F ( {SIR}_{BS - MS - RS} ) = \frac{1}{2} + \frac{1}{2} erf ( \frac{\begin{matrix}{SIR}_{BS - MS - RS} - 10 {log}_{10} ( \frac{{P}_{S} {G}_{S}}{{P}_{I} {G}_{I}} ) - \\ ( {L}_{RS - MS} - {L}_{BS - MS} )\end{matrix}}{\sqrt{2 ( {σ}_{S}^{2} + {σ}_{I}^{2} )}} ) \qquad ( equation 13 )$$

Similarly, the CDF of the signal-to-interference ratio SIR_{BS-MS-RS} of the signal received by the MS from the RS00 to the interference by the BS0 can be represented by the following equation 14.

$$F ( {SIR}_{RS - MS - BS} ) = \frac{1}{2} + \frac{1}{2} erf ( \frac{\begin{matrix}{SIR}_{RS - MS - BS} - 10 {log}_{10} ( \frac{{P}_{S} {G}_{S}}{{P}_{I} {G}_{I}} ) - \\ ( {L}_{BS - MS} - {L}_{RS - MS} )\end{matrix}}{\sqrt{2 ( {σ}_{S}^{2} + {σ}_{I}^{2} )}} ) \qquad ( equation 14 )$$

As an example, when σ_{S}=9.6, σ_{I}=8.2 in the equation 13, and on the other hand when σ_{S}=8.2, σ_{I}=9.6, and ISD (inter-site distance) is 5 km in the equation 14 above, the result (simulation result) of the CDF of the SIR is illustrated in FIGS. 8 and 9. FIG. 8 illustrates the SIR of the signal received by the MS from the BS to the interference by the RS subordinate to the BS. FIG. 9 illustrates the SIR of the signal received by the MS from the RS to the interference by the BS. FIGS. 8 and 9 both illustrate the result of the case in which the RS moves on the line from the BS to the RS. The R in FIG. 8 indicates the distance from the BS to the MS when the distance between the BS and the RS is 10. The R in FIG. 9 indicates the distance from the RS to the MS when the distance between the BS and the RS is 10.

As understood from FIGS. 8 and 9, to suppress serious performance degradation by the interference, it is necessary, for example, to control the R not to exceed 4 in FIG. 8, and not to exceed 3 in FIG. 9. That is, it is hard to guarantee preferable SIRs of the communication link from the BS to the MS and the communication link from the RS subordinate to the BS to the MS regardless of the position of the MS.

FIG. 10 illustrates the request percentile values of the SIR to guarantee the SIR equal to or exceeding −4 dB, 0 dB, and 4 dB for the communication link of the BS and the MS and the communication link of the RS and the MS with respect to the relationship with the normal distance. The normal distance in FIG. 10 indicates the distance from the BS to the MS when the distance between the BS and the RS is 1.

In FIG. 10, in a line on which the SIR is −4 dB, the request percentile value of 0.05 (5%) indicates the probability of 0.05 for the SIR equal to or lower than −4 dB. When the request percentile value (that is, the target quality of the system) is moderated, the normalization distance of the MS for maintaining predetermined quality in each communication link becomes close to 0.5, and the coverage of the BS or the RS becomes large. What is understood from FIG. 10 is that the coverage of the BS or the RS can fluctuate by the setting of the request percentile value of the SIR.

Based on FIGS. 8 through 10, the following (3a) through (3g) can be understood.

That is, in the relay system,

(3a) When the MS is in the position relatively close to the BS, or the MS is close to the cell edge or in the relay zone, there is no mutual interference between the communication link from the BS to the MS and the communication link from the RS to the MS.

(3b) When the MS is in the position in the cell zone in the center between the BS and the RS, the mutual interference between the communication link from the BS to the MS and the communication link from the RS to the MS cannot be ignored. The level of the interference or the evaluation can fluctuate depending on the position of the MS or the target quality of the system.

3. Radio Communication System According to the Second Embodiment

Described above is the interference modes (2-1) through (2-3) in the radio communication system according to the first embodiment in which the frequency reuse rate is 1 in each cell. Based on the explanation, the radio communication system according to the second embodiment is described below.

In the radio communication system according to the second embodiment, an appropriate FFR (fractional frequency reuse) is applied to suppress the interference between the communication links assumed in the relay system. The FFR is a cell/sector setting method for dividing a bandwidth of the downlink or uplink assigned to the system into a plurality of bands for reuse to realize a high frequency reuse efficiency. In the following explanation, in the bandwidth of the downlink or uplink assigned to the system, each band divided by the FFR is expressed as “sub-band”.

(3-1) FFR Applying Method of Radio Communication System According to Second Embodiment

When the FFR is applied in the radio communication system according to the second embodiment, the sub-band is assigned as described in (1A) through (1D) below based on the explanation of the radio communication system according to the first embodiment.

(1A)

A different sub-band is used for each sector to the communication link (hereafter referred to as a first communication link) of the BS and the RS to suppress the interference received by the communication between a BS and its subordinate RS from the communication between the adjacent BS and its subordinate RS.

(1B)

For the communication link (hereafter referred to as a second communication link) between the RS and the MS, a different sub-band than the first communication link is used in each sector to suppress the interference received by the communication between a BS and the MS from the communication between the adjacent BS and its subordinate RS.

(1C)

When the MS exists in the zone (first zone) in the range at a specific distance from the BS, the same sub-band as the second communication link is used in each sector for the communication link (hereafter referred to as a third communication link) between the MS and the BS because it is preferable that the same sub-band as the second communication link is used from the viewpoint of the frequency use efficiency because the mutual interference with the second communication link is hardly detected in the third communication link.

(1D)

A sub-band different from each of the first communication link and the second communication link is used for the communication link (hereafter referred to as a fourth communication link) between the MS and the BS because the interference with the first communication link and/or the second communication link cannot be ignored in the fourth communication link.

In the radio communication system according to the present embodiment, it is preferable that the RS is arranged near the midpoint of the line between two adjacent BS. For example, in FIG. 9, it is preferable that the RS00 is arranged near the midpoint on the line connecting the positions of the adjacent BS0 and BS1. With the arrangement of the RS, in FIG. 9, the RS00 subordinate to the BS0 has low intensity of a received signal of electric waves from the adjacent BS1 to the subordinate RS11 and RS12, thereby hardly generating interference.

(3-2) Example of Applying FFR

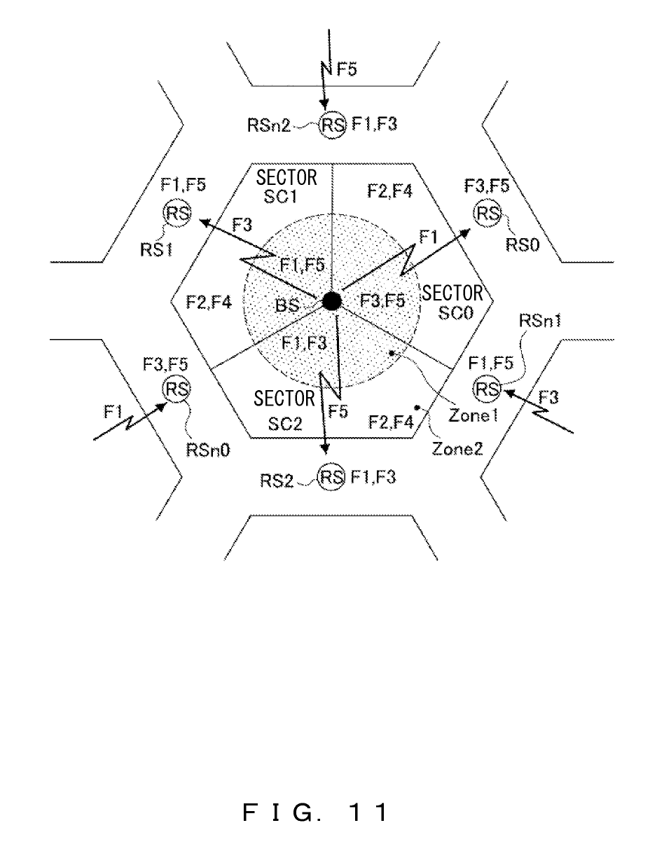

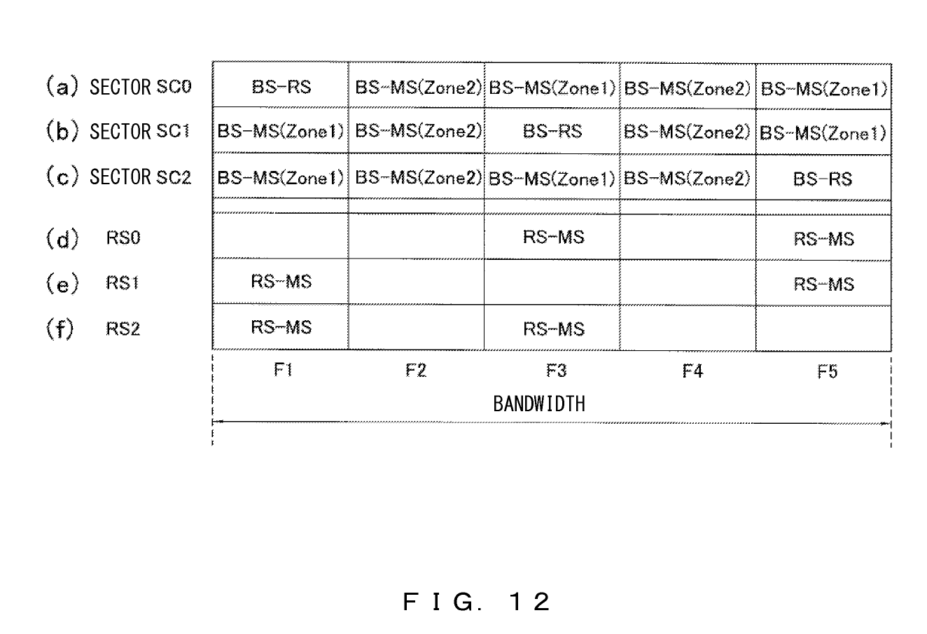

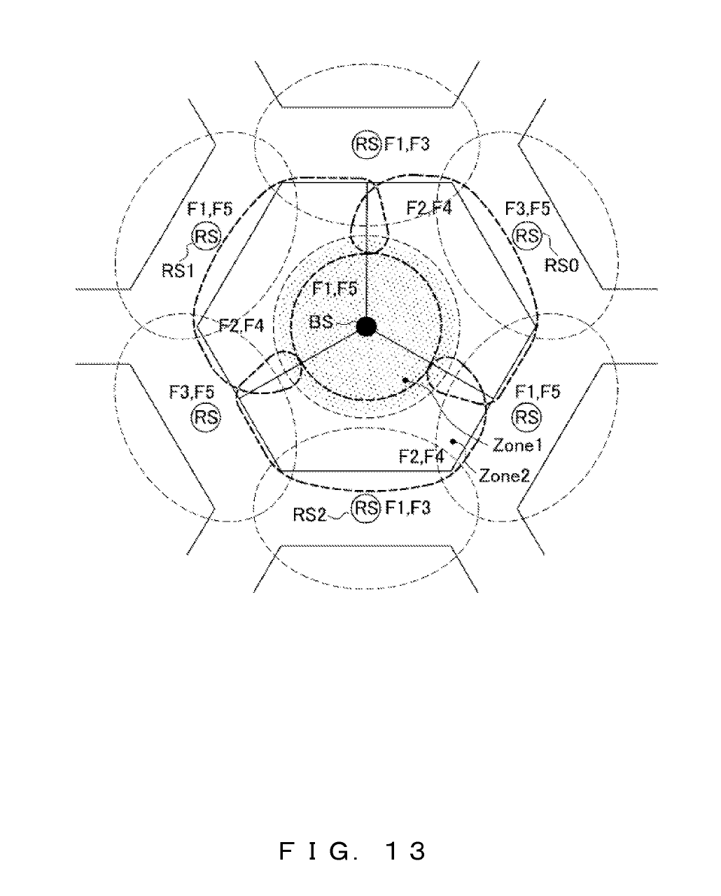

A practical example of applying the FFR when the same cell sector configuration (FIGS. 1 and 2) as the system of the above-mentioned first embodiment in the radio communication system according to the present embodiment is described below with reference to FIGS. 11 through 13. FIG. 11 is a schematic diagram of a sub-band used in each communication link in cell units (as in FIG. 1) in the case of the example of applying the FFR. FIG. 12 illustrates a sub-band used in each communication link for the bandwidth assigned to the system. FIG. 13 is an explanatory view of the coverage by each communication link in the radio communication system in the case of an example of applying the FFR.

As illustrated in FIG. 11, the radio communication system is provided with a BS and RS0 through RS2 respectively corresponding to the sectors SC0 through SC2. In FIG. 11, the zone (first zone) in the range at a specific distance from the BS and near the BS is defined as a zone 1. The zone (second zone) at a longer distance from the BS than the zone 1 is defined as a zone 2. In FIG. 11, relay stations (RSn0, RSn1, and RSn2) subordinate to the adjacent BS are described.

In the radio communication system, according to the above-mentioned FFR applying method, as described in (2A) through (2D) below, a sub-band is assigned to the bandwidth assigned to the system.

(2A)

Different sub-bands F1, F3, F5 (first sub-band, third sub-band, and fifth sub-band) are used for the communication link (first communication link) between the RS0 through RS2 corresponding to the BS and each sector.

(2B)

For the communication link (second communication link) between each of the RS0 through RS2 and the MS, a sub-band different from the first communication link is used in each sector. In the radio communication system in this example, the RS0 communicating with the sub-band F1 with the BS uses the sub-bands F3 and F5 as the second communication link. The RS1 communicating with the BS using the sub-band F3 uses the sub-bands F1 and F5 as the second communication link. The RS2 communicating with the BS using the sub-band F5 uses the sub-bands F1 and F3 as the second communication link. That is, in the two adjacent sectors, the sub-bands used in the second communication link are designed to overlap each other.

(2C)

When the MS is located in the zone 1 (first zone), the same sub-band as in the second communication link is used in each sector for the communication link (third communication link) between the MS and the BS. That is, in the radio communication system in this example, when the MS is located in the sector SC0, the sub-bands F3 and F5 are used as the third communication link. When the MS is located in the sector SC1, the sub-bands F1 and F5 are used as the third communication link. When the MS is located in the sector SC2, the sub-bands F1 and F3 are used as the third communication link.

(2D)

When the MS is located in the zone 2 (second zone), a sub-band different from the first communication link or the second communication link is used for the communication link (fourth communication link) between the MS and the BS. In the radio communication system in this example, the sub-bands F1, F3, and F5 are used for the first communication link and the second communication link. Therefore, in the fourth communication link, sub-bands F2 and F4 (second sub-band, fourth sub-band) different from the sub-bands (F1, F3, and F5) are used for all sectors.

FIG. 12 illustrates the mode of assigning a sub-band as described in (2A) through (2D) above. Items (a) through (c) in FIG. 12 describe the sub-bands assigned for the communication link between the BS and the RS or MS. In FIG. 12, the MS (zone 1) and the MS (zone 2) indicate that the MS is located in the zone 1 and the zone 2 respectively. In the item (a) in FIG. 12, for example, the “BS-RS” indicate that the sub-band F1 is used for the communication link between the BS and the RS0 corresponding to the sector SC0.

Similarly, the items (d) through (f) in FIG. 12 indicate the sub-band assigned to the communication link between the RS0 through RS2 corresponding to each sector and the MS.

FIG. 13 illustrates by dotted lines the coverage by the BS and the RS0 through RS2 in the radio communication system. As illustrated in the figure, the coverage of the RS arranged near the cell includes a part of the cell zone (especially zone 2) of the corresponding sector. Therefore, in each sector, it is understood that the communication link (fourth communication link) from the BS to the MS in the zone 2, and the communication link (second communication link) from the RS to the MS have to use different sub-bands.

In addition, FIG. 13 illustrates that since the same sub-band is used in each sector in the communication link (third communication link) from the BS to the MS in the zone 1 and the communication link (second communication link) from the RS to the MS, settings can be performed not to have overlapping coverage between them. Not to have overlapping coverage between them can be realized also by setting the boundary between the zones 1 and 2, but it is more preferable that the optimization can be acquired by appropriately setting the transmission power from the BS and/or the RS.

Additionally, it is preferable to minimize the overlap between the coverage of the communication link (third communication link) from the BS to the MS in the zone 1 and the coverage of the communication link (second communication link) from the RS to the MS with a view to using the identical frequency. That is, the boundary of the zone in the cell is set to minimize the overlap between the coverage of the third communication link and the coverage of the second communication link under the provided cell arrangement and RS arrangement. The settings of the boundary also depend on the request percentile value (target quality of the system) of the SIR as illustrated in FIG. 10.

The examples of applying the FFR illustrated in FIGS. 11 and 12 are preferable examples of setting the sub-bands used in the second communication link and the third communication link so that they can partly overlap in the two adjacent sectors. By setting the overlapping sub-bands, the frequency use efficiency is furthermore improved.

According to the example of applying the FFR illustrated in FIG. 12, the frequency reuse factor F_{R} in the entire band of the radio communication system according to the second embodiment is expressed as follows. That is, the frequency reuse factor in the sub-bands F2 and F4 is 1, and the frequency reuse factor in the sub-bands F1, F3, and F5 is 5/3. Therefore, as expressed by the following equation 15, F_{R} is 1.4. This value is much larger than the F₁ (=1) of the radio communication system according to the first embodiment, and quantitatively indicates that the frequency use efficiency of the radio communication system according to the second embodiment and the throughput are very high.

$${F}_{R} = \frac{5 \times 3 + 3 \times 2}{3 \times 5} = 1.4 \qquad ( equation 15 )$$

4. Configuration Example of Base Station, Relay Station, and Mobile Station in Radio Communication System According to the Second Embodiment

A typical transmission system in the next generation radio communication system can be an OFDMA (orthogonal frequency division multiple access) system in accordance with IEEE802.16. In the OFDMA system, a plurality of subcarriers in the system band can be adaptively assigned (assignment of frequency resources). The configurations of a base station, a relay station, and a mobile station are described below with reference to the case as an example in wick the radio communication system according to the present embodiment performs a transmission by the OFDMA system in accordance with the above-mentioned example of applying the FFR.

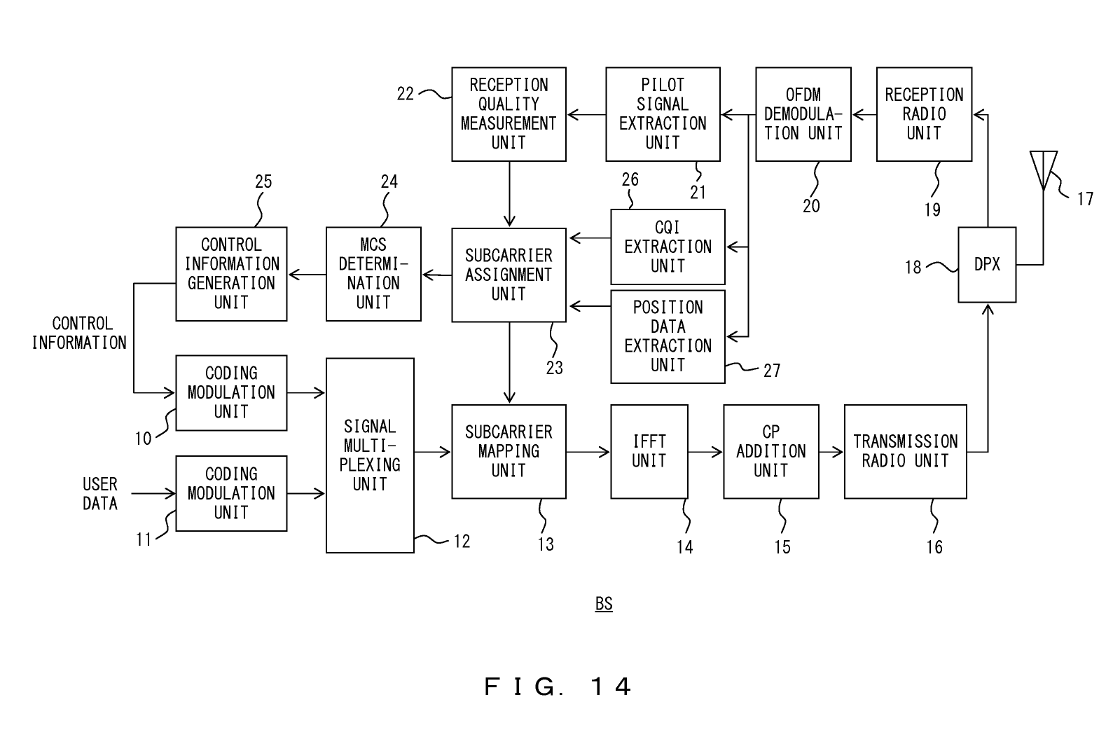

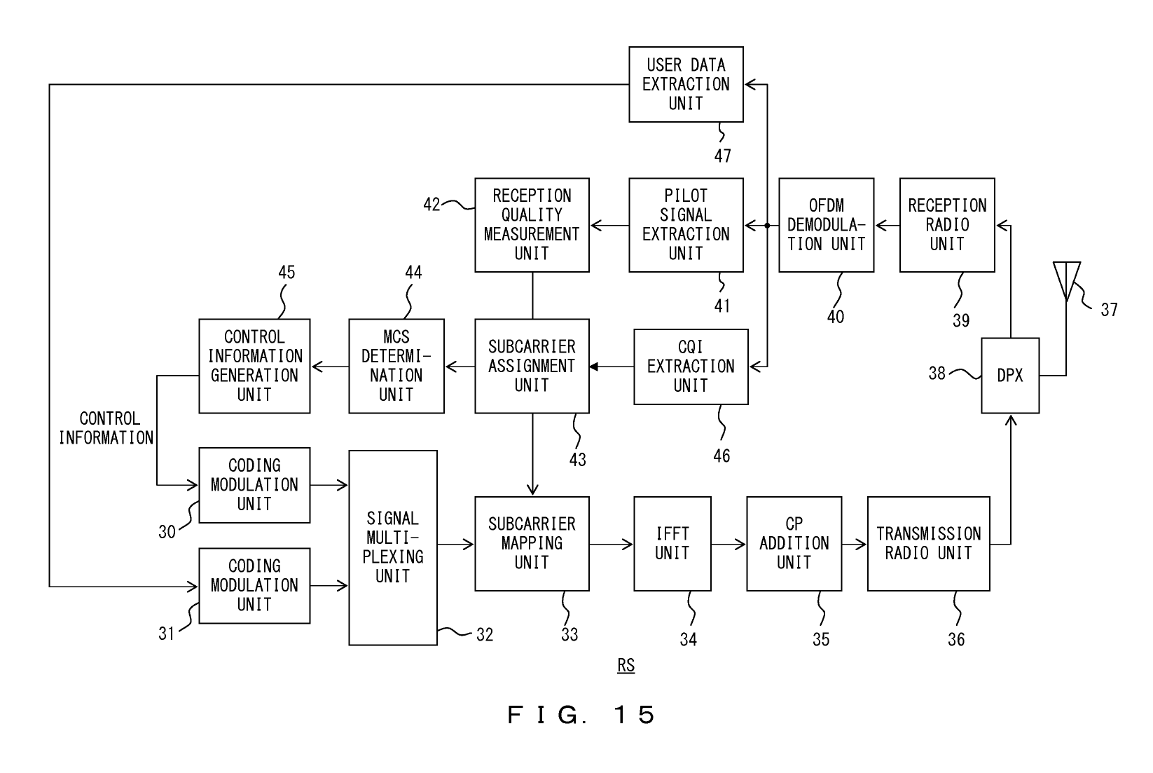

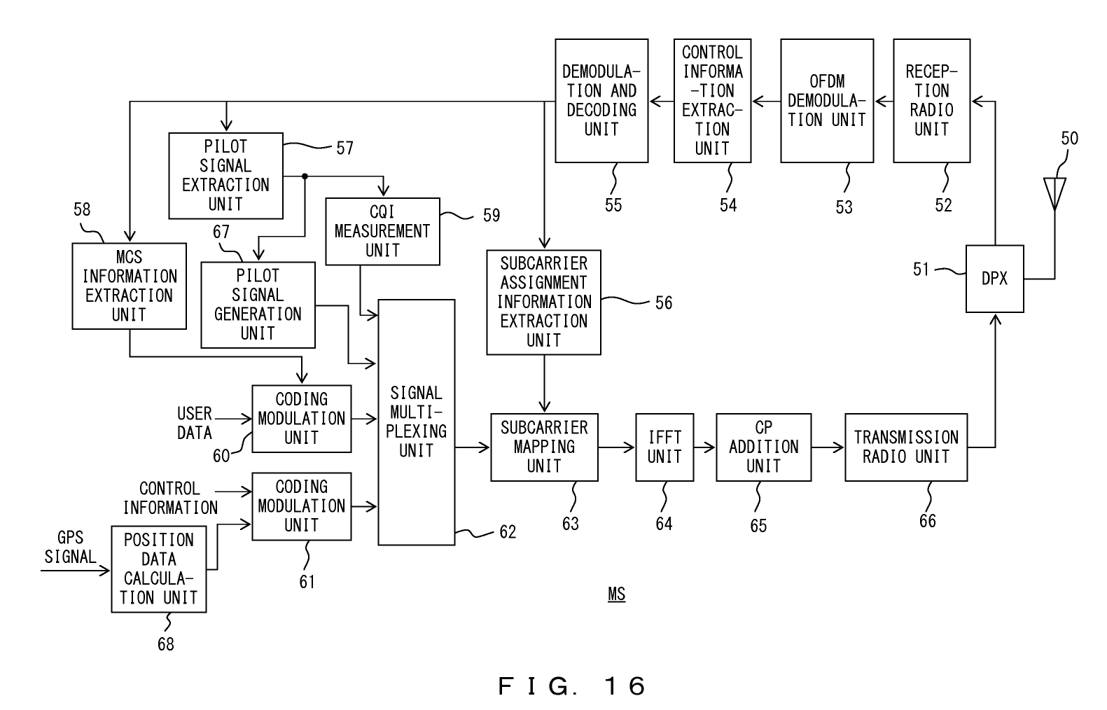

The configurations of the base station (BS), the relay station (RS), and the mobile station (MS) in the radio communication system according to the present embodiment are described below with reference to FIGS. 14 through 16. FIG. 14 is a block diagram of an important part of the internal configuration of a BS. FIG. 15 is a block diagram of an important part of the internal configuration of an RS. FIG. 16 is a block diagram of an important part of the internal configuration of an MS. When the radio communication system according to the present embodiment has a 3-sector configuration illustrated in FIG. 11, it is assumed that the BS has the configuration described below for each sector.

(4-1) Configuration of Base Station (BS)

As illustrated in FIG. 14, the BS includes coding modulation units 10 and 11, a signal multiplexing unit 12, a subcarrier mapping unit 13, an IFFT unit 14, a CP addition unit 15, a transmission radio unit 16, an antenna 17, a duplexer 18, a reception radio unit 19, an OFDM demodulation unit 20, a pilot signal extraction unit 21, a reception quality measurement unit 22, a subcarrier assignment unit 23, an MCS determination unit 24, a control information generation unit 25, a CQI extraction unit 26, and a position data extraction unit 27 (position detection unit). The duplexer 18 (DPX) is provided for sharing the antenna 17 in a transmission and reception system.

The coding modulation unit 10 performs a predetermined error correction coding process on the control information including a bit data sequence, and generates a symbol data sequence signal using a predetermined modulation system (for example, BPSK modulation, QPSK modulation) of a predetermined modulation multi-valued number. The coding rate and the modulation multi-valued number used when the error correction coding process is performed are predetermined and fixed. Generally, the control information is transmitted using a low coding rate by the BPSK modulation or the QPSK modulation because a high quality transmission is required.

The coding modulation unit 11 performs a predetermined error correction coding process on the user data including a bit data sequence, generates a symbol data sequence signal using a predetermined modulation system (for example, QPSK, 16QAM, 64QAM modulation), and outputs the result to the signal multiplexing unit 12. The signal multiplexing unit 12 multiplexes the input from the coding modulation units 10 and 11, and outputs the result The signal multiplexing unit 12 multiplexes the input from the coding modulation units 10 and 11, and outputs the result as a frequency data block to the subcarrier mapping unit 13.

The subcarrier mapping unit 13 maps the frequency data block output from the signal multiplexing unit 12 on a specific subcarrier (hereafter referred to as subcarrier mapping), and outputs the result to the IFFT unit 14. In this case, the subcarrier mapping unit 13 performs mapping using the subcarrier assignment information (number of subcarriers, subcarrier number, etc.) from the subcarrier assignment unit 23.

The IFFT (inverse fast Fourier transform) unit 14 performs an inverse fast Fourier transform on the output of the subcarrier mapping unit 13, and outputs the result to the CP addition unit 15. The CP addition unit 15 inserts the guard section using a CP (cyclic prefix) into the transmission data input from the IFFT unit 14, and outputs the result to the transmission radio unit 16.

After up-converting the transmission data from the CP addition unit 65 from the baseband frequency to the radio frequency, the transmission radio unit 16 emits the result from the antenna 17 to a space area.

The reception radio unit 19 performs an amplifying process, a band restricting process, and a frequency converting process on the received radio signal, and outputs a complex baseband signal configured by an inphase signal and a quadrature phase signal in response to the received radio signal.

The OFDM demodulation unit 20 performs the OFDM demodulation on each of the input baseband signals. That is, after the time and frequency synchronous process, the GI (guard interval) removing process, the FFT (fast Fourier transform) process, and the serial-parallel converting process are performed.

The pilot signal extraction unit 21 extracts the pilot signal transmitted from the MS or the RS from the received signal input by the OFDM demodulation unit 20, and outputs the signal to the reception quality measurement unit 22. The CQI extraction unit 26 extracts the channel quality information (CQI) transmitted from the MS from the received signal input from the OFDM demodulation unit 20, and outputs the information to the subcarrier assignment unit 23.

The reception quality measurement unit 22 measures the reception quality for each subcarrier based on the output of the pilot signal extraction unit 21. Practically, the reception quality measurement unit 22 measures the reception quality for each subcarrier using the pilot signal from the pilot signal extraction unit 21, and outputs the measurement result to the subcarrier assignment unit 23. As the reception quality, an arbitrary measurement value such as the CIR (carrier to interference ratio) or the SIR (signal-to-interference ratio), the SNR (signal to noise ratio), etc. is used.

The subcarrier assignment unit 23 assigns the subcarrier of the downlink for the MS or the RS using the CQI of each subcarrier extracted by the CQI extraction unit 26. Practically, the subcarrier assignment unit 23 sets the number of subcarriers, the subcarrier number, etc. as the subcarrier assignment information. In this example, a subcarrier indicating preferable CQI from the MS or the RS is assigned.

The subcarrier assignment unit 23 assigns a subcarrier in the uplink from the MS or the RS using the reception quality for each subcarrier which is measured by the reception quality measurement unit 22. Practically, the subcarrier assignment unit 23 sets the number of subcarriers, the subcarrier number, etc. as the subcarrier assignment information. In this example, a subcarrier indicating preferable reception quality from the MS or the RS is assigned.

In addition, when the subcarrier assignment unit 23 communicates with the MS directly without the RS, it assigns the subcarrier of the downlink or the uplink for the MS using the position data of the MS extracted by the position data extraction unit 27. For example, when the MS belongs to the zone 1 based on the position data, the subcarrier assignment unit 23 corresponding to the sector SC0 assign s the subcarrier from the sub-bands F3 and F5 to the MS, and when the MS belongs to the zone 2, it assigns a subcarrier from the sub-bands F2 and F4 to the MS (FIG. 12).

The subcarrier assignment unit 23 is an embodiment of the first communication unit and the second communication unit.

That is, the subcarrier assignment unit 23 adaptively assigns a subcarrier indicating preferable signal quality of the downlink or the uplink in the band (FIG. 12) predetermined based on the communication partner (RS or MS) and the position of the MS if the communication partner is the MS depending on the corresponding sector. Then, the subcarrier assignment unit 23 outputs the subcarrier assignment information to the subcarrier mapping unit 13 and the MCS determination unit 24.

The MCS determination unit 24 adaptively selects the MCS (modulation and coding scheme) information such as a modulation multi-valued number, a coding rate, etc. for each subcarrier or for each subcarrier block including a plurality of subcarriers as a set based on the subcarrier assignment information from the subcarrier assignment unit 23 and the information about the reception quality of each subcarrier, and outputs the information to the control information generation unit 25. The control information generation unit 25 generates a control signal including the MCS information and the subcarrier assignment information, and outputs the signal as control information to the coding modulation unit 10.

(4-2) Configuration of Relay Station (RS)

The RS performs an operation similar to that of the BS as viewed from the MS, and the configuration is similar to the configuration of the BS as illustrated in FIG. 15. In the description below, the component of the BS illustrated in FIG. 15 and also illustrated in FIG. 14 is not double described.

Since the band of the communication between the BS and the RS is different from the band of the communication between the RS and MS in the radio communication system, it is necessary to reset the assignment of the subcarrier in the RS.

The assignment of the subcarrier is reset as follows.

First, a user data extraction unit 47 extracts user data transmitted from the BS or the MS according to the received signal input from an OFDM demodulation unit 40. The extracted user data is fetched as a frequency data block into a subcarrier mapping unit 33 through a coding modulation unit 31 and a signal multiplexing unit 32.

A subcarrier assignment unit 43 adaptively assigns a subcarrier indicating higher signal quality in the bands (FIG. 12) determined based on the communication partner (BS or MS) depending on the corresponding sector. For example, when the RS0 corresponding to the sector SC0 relays the downlink from the BS to the MS, a subcarrier of higher signal quality is assigned from between the sub-bands F3 and F5. Thus, in the RS, for example, in the downlink, after the user data is once extracted from the received signal from the BS, it is newly mapped to the subcarrier in the band assigned to the communication between the RS and the MS.

The subcarrier assignment unit 43 is an embodiment of the third communication unit.

(4-3) Configuration of Mobile Station (MS)

As illustrated in FIG. 16, the MS includes an antenna 50, a duplexer 51, a reception radio unit 52, an OFDM demodulation unit 53, a control information extraction unit 54, a demodulation and decoding unit 55, a subcarrier assignment information extraction unit 56, a pilot signal extraction unit 57, an MCS information extraction unit 58, a CQI measurement unit 59, a coding modulation unit 60, a coding modulation unit 61, a signal multiplexing unit 62, a subcarrier mapping unit 63, an IFFT unit 64, a CP addition unit 65, a transmission radio unit 66, a pilot signal generation unit 67, and a position data calculation unit 68. The duplexer 51 (DPX) is provided for sharing the antenna 50 in a transmission and reception system.

The coding modulation unit 60 performs a predetermined error correction coding process on the user data including a bit data sequence, generates a symbol data sequence signal using a modulation system (for example, QPSK, 16 QAM, 64 QAM modulation) of a predetermined modulation multi-valued number, and outputs the signal to the signal multiplexing unit 62. The MCS (modulation and coding schemes) information relating to the coding rate and the modulation multi-valued number when the error correction coding process is performed is set based on the output of the MCS information extraction unit 58 for outputting the MCS information from the control signal transmitted from the BS. The setting can realize the adaptive modulation depending on the propagation path state.

The coding modulation unit 61 performs a predetermined error correction coding process on the control information including a bit data sequence, and generates a symbol data sequence signal using the schematic diagram (for example, BPSK modulation, QPSK modulation) of a predetermined modulation multi-valued number. In this case, the coding rate and the modulation multi-valued number when the error correction coding process is performed are predetermined and fix. Since the control information generally requires a high-quality transmission, it is transmitted at a low coding rate in the BPSK modulation or the QPSK modulation.

The position data calculation unit 68 sequentially calculates the position data of the local state by receiving a GPS signal from the GPS (global positioning system) satellite not illustrated in the attached drawings. The GPS position measuring system is a method of calculating a position based on the triangulation from the arrival time of the signal received from four or more GPS satellites. The position data is input together with the control information to the coding modulation unit 61. The method of calculating the position of the local station in the position data calculation unit 68 can be any well-known position calculating method in addition to the method using the GPS signal. For example, although inferior in accuracy to the GPS position measuring system, a method of calculating the position based on the principle of the triangulation from the delay time of the synchronous signal received from three or more BSs.

The signal multiplexing unit 62 multiplexes the input from the coding modulation units 60 and 61, and outputs the result as a frequency data block to the subcarrier mapping unit 63.

The subcarrier mapping unit 63 maps the frequency data block output from the signal multiplexing unit 62 on a specific subcarrier (hereafter referred to as subcarrier mapping), and outputs the result to the IFFT unit 64. In this case, the subcarrier mapping unit 63 performs mapping using the subcarrier assignment information (number of subcarriers, subcarrier number, etc.) extracted by the subcarrier assignment information extraction unit 56.

The IFFT unit 64 performs an inverse fast Fourier transform on the output of the subcarrier mapping unit 63, and outputs the result to the CP addition unit 65. The CP addition unit 65 inserts the guard section using a CP (cyclic prefix) into the transmission data input from the IFFT unit 64, and outputs the result to the transmission radio unit 66. After up-converting the transmission data from the CP addition unit 65 from the baseband frequency to the radio frequency, the transmission radio unit 66 emits the result from the antenna 50 to a space area.

The reception radio unit 52 performs an amplifying process, a band restricting process, and a frequency converting process on the radio signal received by the antenna 50, and outputs a complex baseband signal configured by an inphase signal and a quadrature phase signal.

The OFDM demodulation unit 53 performs the OFDM demodulation on each of the input baseband signals. That is, after the time and frequency synchronous process, the GI (guard interval) removing process, the FFT (fast Fourier transform) process, and the serial-parallel converting process are performed.

The control information extraction unit 54 extracts the control information from the BS according to the received signal input from the OFDM demodulation unit 53, and outputs the information to the demodulation and decoding unit 55. The control signal includes subcarrier assignment information, a pilot signal, and MCS information. The subcarrier assignment information extraction unit 56, the pilot signal extraction unit 57, and the MCS information extraction unit 58 extracts subcarrier assignment information, a pilot signal, and MCS information from the control information processed by the demodulation and decoding unit 55 in the demodulating process and the decoding process.

The subcarrier assignment information extraction unit 56 and the subcarrier mapping unit 63 configures a fourth, fifth, and sixth communication units.

The CQI measurement unit 59 measures the channel quality information (CQI) about each subcarrier based on the output of the pilot signal extraction unit 57. Practically, the CQI measurement unit 59 measures the CQI of each subcarrier using a pilot signal from the pilot signal extraction unit 57, and outputs it to the signal multiplexing unit 62. As the CQI, any measured value such as a CIR (carrier to interference ratio) or a SIR (signal to interference ratio), an SNR (signal to noise ratio), etc. according to the pilot signal can be applied. The CQI of each subcarrier expresses the signal quality of the downlink to the MS. The CQI of each subcarrier is transmitted to the BS or the RS, and is used in assigning a subcarrier of the downlink to the MS.

The pilot signal generation unit 67 generates a pilot signal as a signal sequence which is known in advance to the BS or the RS, and outputs it to the signal multiplexing unit 62. The signal sequence used as the pilot signal is set based on the output of the pilot signal extraction unit 57.

With the configurations of the BS, the RS, and the MS above, a high quality radio communication can be realized by a subcarrier of a band assigned to each communication in the radio communication in the OFDMA system between the BS and the RS, and between the RS and the MS. In this case, in the RS, a subcarrier is reassigned depending on the change of a band.

5. Control of Transmission Power by Base Station and/or Relay Station

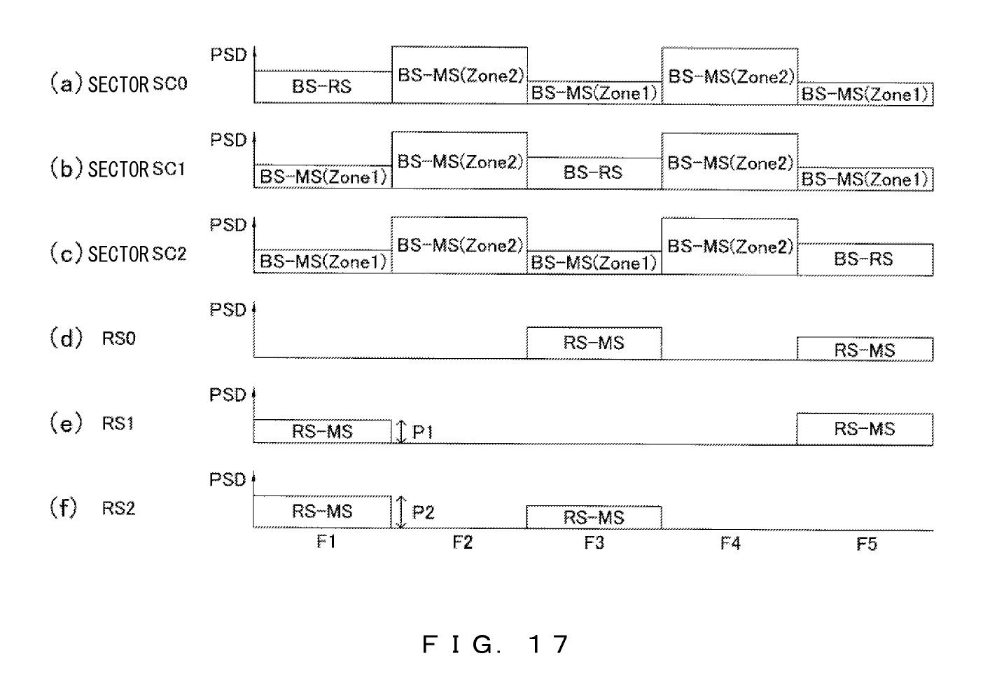

Appropriate control of the transmission power by a BS and/or an RS as an example of a preferable variation of the radio communication system according to the second embodiment is described below with reference to FIG. 17. FIG. 17 is an explanatory view of the preferable transmission power of a BS and/or RS in the radio communication system according to an embodiment of the present invention.

The items (a) through (c) in FIG. 17 illustrate the relationship between the sub-band assigned to the communication link between the BS and the RS or the BS and the MS and the transmission power (PSD: power spectrum density) of the BS in each sector. In FIG. 17, the MS (zone 1) and the MS (zone 2) indicate that the MS is located in the zones 1 and 2 respectively. The items (d) through (f) in FIG. 17 indicate the relationship between the sub-band assigned to the communication link between the RS0 and RS2 corresponding to each sector and the MS and the transmission power (PSD) of the RS. In FIG. 17, the sub-band for each communication link is the same as that illustrated in FIG. 12.

(5-1) Control of Transmission Power from BS to MS

In the radio communication system according to the second embodiment, as described above in (3-1) (1C), when the MS is located in the zone 1 (first zone) in the range of a specific distance from the BS, the same sub-band as in the second communication link is used in each sector for the communication link (third communication link) between the MS and the BS. In this case, since the zone 1 above is an area relatively close to the BS, it is preferable from the viewpoint of power efficiency to reduce the transmission power from the BS as compared with the communication link (fourth communication link) to the MS located farther than the zone 1. Furthermore, it is also preferable to reduce the transmission power for the MS in the zone from the viewpoint of avoiding the interference with the communication from the adjacent BS to the subordinate RS.

In an example of the 3-sector radio communication system described above with reference to FIGS. 11 and 12, as illustrated in FIG. 17 (a) through (c), a setting is performed so that the PSD in the third communication link (BS-MS (zone 1)) can be lower than the PSD in the fourth communication link (BS-MS (zone 2)). With the setting, as illustrated in FIG. 11, for example, in the third communication link (BS-MS (zone 1)) using the sub-bands F3 and F5 in the sector SC0, the interference with the communication (respectively using the sub-bands F3 and F5) from the adjacent BS to the subordinate RSn1 and Rsn2 can be avoided. Similarly, in the third communication link (BS-MS (zone 1)) using the sub-bands F1 and F5 in the sector SC1, the interference with the communication (respectively using the sub-bands F1 and F5) from the adjacent BS to the subordinate RSn0 and Rsn2 can be avoided. In the third communication link (BS-MS (zone 1)) using the sub-bands F1 and F3 in the sector SC2, the interference with the communication (respectively using the sub-bands F1 and F3) from the adjacent BS to the subordinate RSn0 and Rsn1 can be avoided.

(5-2) Control of Transmission Power from BS to RS

To avoid the interference between the communication from the BS to the MS in the zone 1 and the communication from the adjacent BS to the subordinate RS, it is preferable to somewhat reduce the transmission power from the BS to the RS. From the viewpoint described above, it is effective to set the value of the transmission power from the BS to the RS between the value of the transmission power from the BS to the MS in the zone 1 and the value of the transmission power from the BS to the MS in the zone 2 (second zone).

(5-3) Control of Transmission Power from RS to MS

In the radio communication system according to the second embodiment, as illustrated in (3-1) (1B) above, a sub-band different from in the first communication link (communication link between the BS and the RS) is used for the communication link (second communication link) between the RS and the MS in each sector. Therefore, to efficiently use the band regulated on the system in each sector, it is preferable, as described above, to overlap the sub-band used in the second communication link in the adjacent two-sector RS. In this case, in the overlapping bands, it is further preferable to perform a setting so that the transmission power of one RS in the adjacent 2-sector RS can be lower than the transmission power of another RS. Thus, the interference between the downlinks from the adjacent 2-sector RS to MS can be avoided.

The example of the 3-sector radio communication system illustrated above with reference to FIGS. 11 and 12 is described as follows. That is, as illustrated by (e) and (f) in FIG. 17, a setting is performed in the sub-band F1 double used in the adjacent sectors RS1 and RS2, the transmission power (P1 in FIG. 17) of one RS1 can be lower than the transmission power (P2 in FIG. 17) of another RS2 (that is, P1<P2). As illustrated in FIG. 7 (d) and (f), a setting is performed in the sub-band F3 double used in the adjacent sectors RS0 and RS2, the transmission power of the RS2 can be lower than the transmission power of another RS0. As illustrated in FIG. 7 (d) and (f), a setting is performed in the sub-band F5 double used in the adjacent sectors RS0 and RS1, the transmission power of the RS0 can be lower than the transmission power of another RS1.

With the settings above, in FIG. 11, for example, the RS0 of the sector SC0 (using the sub-bands F3 and F5) can avoid the interference in the communication in the downlink using the sub-band F5 overlapping with the adjacent RSn1 (RS using the sub-bands F1 and F5) subordinate to another BS. Similarly, the RS0 (using the sub-bands F3 and F5) can avoid the interference in the communication in the downlink using the sub-band F3 overlapping with the adjacent RSn2 (RS using the sub-bands F1 and F3) subordinate to another BS.

As the configuration of hardware or software for controlling the transmission power, any configuration well known by those skilled in the art can be used.

6. Performance Evaluation of Radio Communication System According to the Second Embodiment

The Inventor has evaluated the performance based on the simulation of the system level to verify the performance improvement of the radio communication system according to the second embodiment.

(6-1) Preconditions of Simulation

The simulation has been performed under the conditions listed in the following tables 1 through 4. Table 1 lists the parameters relating to the configurations of the cell and the network in the simulation. Table 2 lists the preconditions of the system level in the simulation. Table 3 lists the conditions of the path loss and the shadowing attenuation in each communication link in the simulation. In the simulation, the mode of the cell and the arrangement of the RS corresponding to the sector are the same as those in FIG. 1.

TABLE 1

| PARAMETER | VALUE | |
|---|---|---|
| NUMBER OF CLUSTERS | 7 | |
| NUMBER OF CELLS OF EACH CLUSTER | 19 | |
| NUMBER OF RS OF EACH CELL | 3 | |
| DISTANCE BETWEEN BSs | 5 | km |
| DISTANCE BETWEEN BS AND RS | 2.5 | km |

TABLE 2

| PARAMETER | VALUE | |
|---|---|---|
| CARRIER FREQUENCY | 2.0 | GHz |
| FREQUENCY BAND | 10 | MHz |
| MINIMUM DISTANCE BETWEEN BS AND MS | 35 | METERS |
| TRANSMISSION POWER OF BS | 46 | dBm |
| ANTENNA GAIN OF BS | 14 | dBi |
| NOISE VALUE OF BS | 5 | dB |
| THERMAL NOISE DENSITY OF BS | −174 | dBm/Hz |
| OTHER LOSSES OF BS | 5 | dB |
| ANTENNA PATTERN OF BS | 70° | beam-width |
| TRANSMISSION POWER OF RS | 46 | dBm |
| ANTENNA GAIN OF RS | 5 | dBi |
| NOISE FIGURE OF RS | 7 | dB |
| THERMAL NOISE DENSITY OF RS | −174 | dBm/Hz |
| OTHER LOSSES OF RS | 5 | dB |
| ANTENNA PATTERN OF RS | OMNIDIRECTIONAL | |
| ANTENNA GAIN OF MS | 0 | dBi |
| NOISE FIGURE OF MS | 9 | dB |
| THERMAL NOISE DENSITY OF MS | −174 | dBm/Hz |
| OTHER LOSSES OF MS | 10 | dB |

| | |
|---|---|
| ANTENNA PATTERN OF MS | OMNIDIRECTIONAL |

TABLE 3

| PARAMETER | VALUE | REMARKS |
|---|---|---|
| PATH LOSS BETWEEN | 126.0 + 47.5 log₁₀ | d IS km VALUE |
| BS AND MS | (d) | ANTENNA HEIGHT IS 32 m |
| STANDARD FACTOR | 9.6 dB | STANDARD DEVIATION |
| BETWEEN BS AND MS | | |
| PATH LOSS BETWEEN | 105.1 + 40.7 log₁₀ | d IS km VALUE |
| BS AND RS | (d) | ANTENNA HEIGHT IS 15 m |
| STANDARD FACTOR | 3.4 dB | STANDARD DEVIATION |
| BETWEEN BS AND RS | | |
| PATH LOSS BETWEEN | 128.9 + 50.4 log₁₀ | d IS km VALUE |
| RS AND MS | (d) | ANTENNA HEIGHT IS 3 m |
| STANDARD FACTOR | 8.2 dB | STANDARD DEVIATION |
| BETWEEN RS AND MS | | |
| PATH LOSS BETWEEN | 113.1 + 48.6 log₁₀ | d IS km VALUE |
| RSs | (d) | ANTENNA HEIGHT IS 15 m |
| STANDARD FACTOR | 3.4 dB | STANDARD DEVIATION |
| BETWEEN RSs | | |

In this simulation, the radio communication system according to the first embodiment and the radio communication system according to the second embodiment in FIG. 17 (when transmission power is controlled) are compared with each other in geometry and throughput. The geometry refers to the long-term signal-to-interference and noise ratio (SINR). The long-term SINR is calculated to ignore the influence by the initial fading.

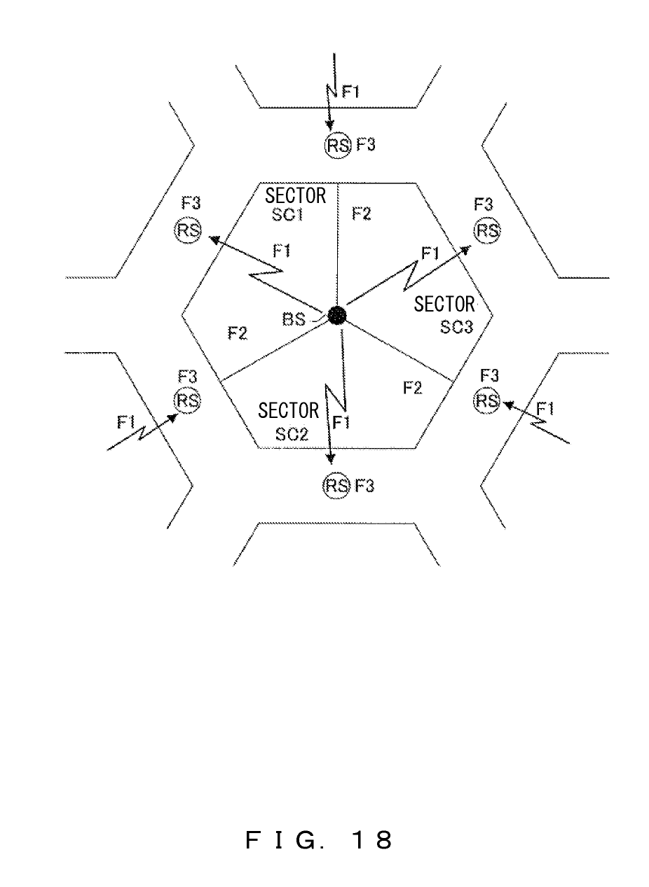

The radio communication system according to the first embodiment is designed as a simulation model so that the frequency reuse factor can be 1 for each of the communication link of the BS and the RS, the communication link of the BS and the MS, and the communication link of the RS and the MS as illustrated in FIG. 18. That is, in the radio communication system according to the first embodiment, the sub-band F1 is used for each sector for the communication link of the BS and the RS. The sub-band F2 is used for each sector for the communication link of the BS and the MS. The sub-band F3 is used for each sector for the communication link of the RS and the MS.

The transmission power is controlled as listed in the table 4 below on the radio communication system according to the second embodiment as a simulation model. In the table 4, items are listed in the same order as each communication link of (a) through (f) in FIG. 17. In table 4, the transmission power of the BS or the RS in each communication link is listed by the ratio indicated when the transmission power for the MS in the zone 1 from the BS in each sector is 10.

TABLE 4

| SUB-BAND | F1 | F2 | F3 | F4 | F5 |
|---|---|---|---|---|---|
| SECTOR SC0 | 5 | 10 | 1 | 10 | 1 |
| SECTOR SC1 | 1 | 10 | 5 | 10 | 1 |
| SECTOR SC2 | 1 | 10 | 1 | 10 | 5 |
| RS0 | 0 | 0 | 2 | 0 | 1 |
| RS1 | 1 | 0 | 0 | 0 | 2 |
| RS2 | 2 | 0 | 1 | 0 | 0 |

(6-2) Result of Geometry Performance

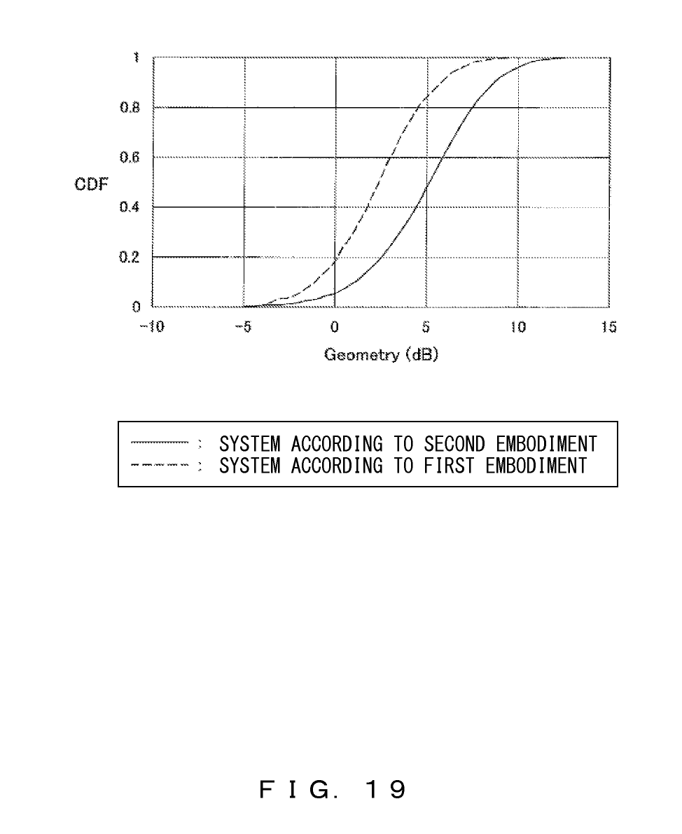

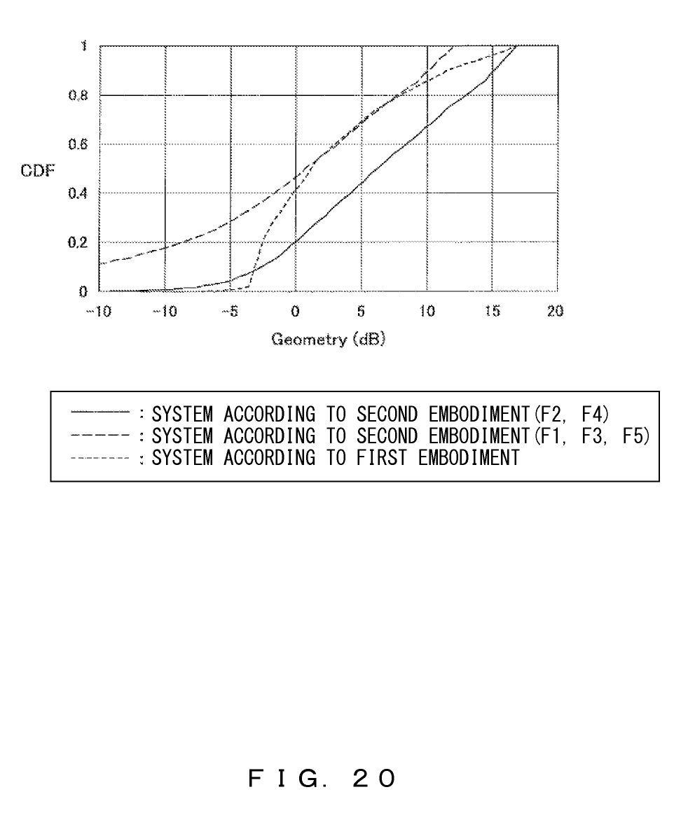

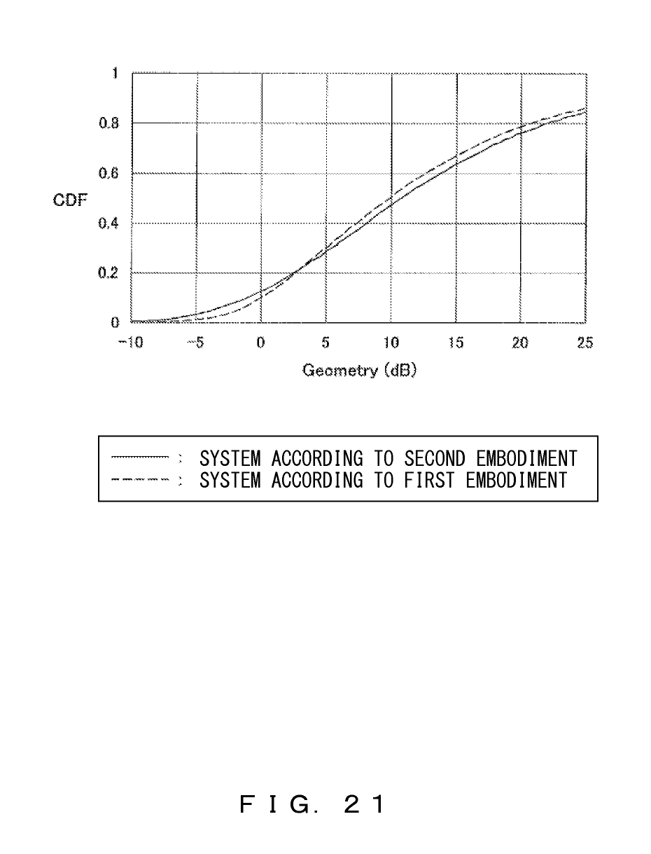

FIGS. 19 through 21 illustrate the result of the geometry performance conducted under the preconditions above. FIG. 19 illustrates a CDF of the geometry in the communication link of the BS and the RS. FIG. 20 illustrates a CDF of the geometry in the communication link of the BS and the MS. FIG. 21 illustrates a CDF of the geometry in the communication link of the RS and the MS.

As illustrated in FIG. 19, in the radio communication system according to the second embodiment, about 3 dB gain improvement can be attained in the communication link of the BS and the RS as compared with the first embodiment. As illustrated in FIG. 20, in the radio communication system according to the second embodiment, when the MS is in the second zone (using the sub-bands F2 and F4) in the communication link of the BS and the MS, about 5 dB gain is attained in the range of the geometry of 0 through 15 dB. When the MS is in the zone 1 (using the sub-bands F1, F3, and F5), a loss occurs when the geometry is low, but the result is not very different from the result of the radio communication system according to the first embodiment when the geometry is in the range of 0 dB or more. As illustrated in FIG. 21, in the radio communication system according to the second embodiment, the geometry in the communication link of the RS and MS is almost the same as that in the system according to the first embodiment.

Thus, relating to the geometry performance, the radio communication system according to the second embodiment excels the system according to the first embodiment.

(6-3) Result of the Throughput Performance

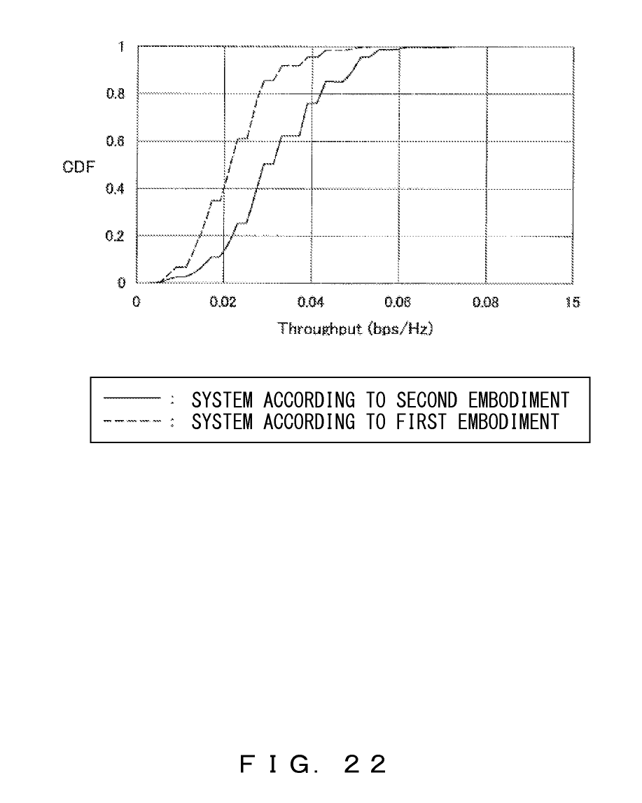

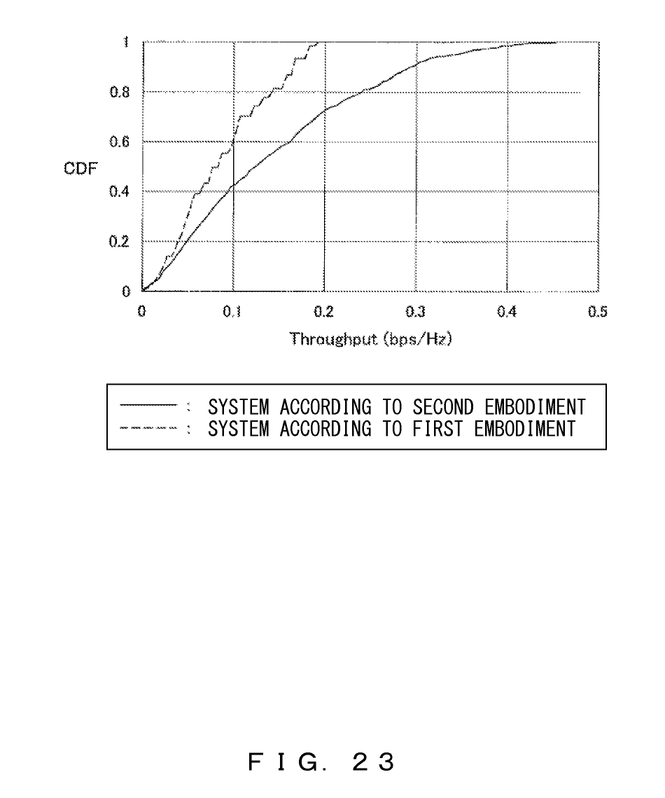

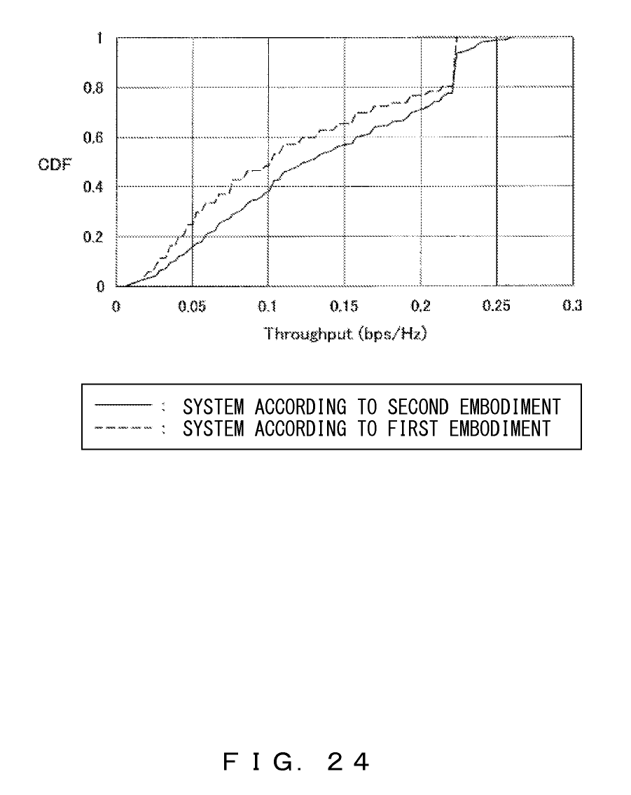

FIGS. 22 through 24 and Table 5 illustrate the result of the threshold performance conducted under the preconditions above. FIG. 22 illustrates a CDF of the user throughput in the communication link of the BS and the RS. FIG. 23 illustrates a CDF of the user throughput in the communication link of the BS and the MS. FIG. 24 illustrates a CDF of the user throughput in the communication link of the RS and the MS. Table 5 illustrates the result of the sector throughput (bps/Hz) in each communication link. In this throughput performance evaluation, in addition to the preconditions above, ten MSs are provided in each sector, and the scheduling has been performed equally on each MS.

TABLE 5

| COMMUNICATION LINK | BS-RS | BS-MS | RS-MS |
|---|---|---|---|
| RADIO COMMUNICATION | 0.228944 | 0.897864 | 1.155535 |
| SYSTEM ACCORDING TO | | | |
| FIRST EMBODIMENT | | | |
| RADIO COMMUNICATION | 0.327074 | 1.483459 | 1.343952 |
| SYSTEM ACCORDING TO | | | |
| SECOND EMBODIMENT | | | |

As clearly indicated in FIGS. 22 through 24, relating to the throughput performance, the radio communication system according to the second embodiment excels the system according to the first embodiment.

As described above, in the radio communication system according to the first embodiment and the second embodiment, for the first communication link a different sub-band is used for each sector to the first communication link so that the interference received by the communication between a BS and its subordinate RS from the radio communication between an adjacent BS and its subordinate RS can be suppressed. In this radio communication system, for the second communication link between the relay station and the mobile station, a different sub-band than the first communication link is used in each sector, so that the interference received by the communication between the BS and the MS from the communication between the adjacent BS and its subordinate RS can be suppressed. In this radio communication system, for the fourth communication link between the MS and the BS, a sub-band different from each of the first communication link and the second communication link is used, so that the interference with the first communication link and/or the second communication link in the fourth communication link can be suppressed. Thus, in the radio communication including a relay station which relays communications between the BS and the MS, the interference among the communication links can be suppressed.

Described below is an example of a hardware configuration of the radio base station. The radio base station includes a radio IF (interface), a processor, memory, a logical circuit, a cable IF, etc. The radio IF is an interface device for performing radio communications with a radio terminal. The processor is a device for processing data, and can be, for example, a CPU (central processing unit), a DSP (digital signal processor), etc. The memory is a device for storing data, and can be, for example, ROM (read only memory), RAM (random access memory), etc. The logical circuit is an electronic circuit for performing a logical operation, and can be, for example, an LSI (large scale integration), an FPGA (field-programming gate array), etc. The cable IF is an interface device for performing cable communications with other radio base stations etc. connected to a network on the network side of the mobile telephone system (so-called backhaul network).

The correspondence between the radio base station illustrated in FIG. 14 and the hardware is, for example, described below. The radio IF corresponds to, for example, the antenna 17. The processor, the logical circuit, and the memory correspond to, for example, the coding modulation units 10 and 11, (omitted), and the position data extraction unit 27. The cable IF is not illustrated in the attached drawings.

Described below is an example of a hardware configuration of the relay station. The relay station includes a radio IF (interface), a processor, memory, a logical circuit, etc. The radio IF is an interface device for performing radio communications with a radio terminal. The processor is a device for processing data, and can be, for example, a CPU (central processing unit), a DSP (digital signal processor), etc. The memory is a device for storing data, and can be, for example, ROM (read only memory), RAM (random access memory), etc. The logical circuit is an electronic circuit for performing a logical operation, and can be, for example, an LSI (large scale integration), an FPGA (field-programming gate array), etc.

The correspondence between the relay station illustrated in FIG. 15 and the hardware is, for example, described below. The radio IF corresponds to, for example, the antenna 37. The processor, the logical circuit, and the memory correspond to, for example, the coding modulation unit 30, (omitted), and the user data extraction unit 47.

Described below is an example of a hardware configuration of the radio terminal. The radio terminal includes a radio IF (interface), a processor, memory, a logical circuit, an input IF, an output IF, etc. The radio IF is an interface device for performing radio communications with a radio terminal. The processor is a device for processing data, and can be, for example, a CPU (central processing unit), a DSP (digital signal processor), etc. The memory is a device for storing data, and can be, for example, ROM (read only memory), RAM (random access memory), etc. The logical circuit is an electronic circuit for performing a logical operation, and can be, for example, an LSI (large scale integration), an FPGA (field-programming gate array), etc. The input IF is a device for performing an inputting operation, and can be, for example, an operation button, a microphone, etc. The output IF is a device for performing an outputting operation, and can be, for example, a display, a speaker, etc.

The correspondence between the radio terminal illustrated in FIG. 16 and the hardware is, for example, described below. The radio IF corresponds to, for example, an antenna. The processor, the logical circuit, and the memory correspond to, for example, the duplexer 51, (omitted), and the position data calculation unit 68. The input IF and the output IF are not illustrated in the attached drawings.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has (have) been described in detail, it should be understood that the various changes, substitutions, and alterations could be made hereto without departing from the spirit and scope of the invention.

What is claimed is:

1. A radio communication system comprising:
a base station,
a mobile station, and
a relay station which is provided for each sector, and relays communications between the base station and the mobile station, configured to divide an assigned band into a plurality of sub-bands for use,
wherein:
a different sub-band is used for each sector for a first communication link of the base station and the relay station;
a sub-band different from the sub-band in the first communication link is used for each sector for a second communication link of the relay station and the mobile station;
when the mobile station is located in a first zone in a range of a specific range from the base station, a substantially same sub-band as the second communication link is used in each sector for a third communication link of the mobile station and the base station;
when the mobile station is located in a second zone farther from the base station than the first zone, a sub-band different from those of the first communication link and the second communication link is used for a fourth communication link of the mobile station and the base station.

2. The system according to claim 1, wherein
sub-bands used in the second communication link are set so that they overlap each other in two adjacent relay stations.

3. The system according to claim 1, wherein:
first, second, and third sectors form the system including a 3-sector configuration;
in the first communication link, first, second and third sectors respectively use a first sub-band, a third sub-band, and a fifth sub-band;
in the second communication link, the first sector uses the third and fifth sub-bands, the second sector uses the first and fifth sub-bands, and the third sector uses the first and third sub-bands;
in the fourth communication link, all sectors use the second and fourth sub-bands.

4. The system according to claim 2, wherein
in a relay station of two adjacent sectors, in a band in which sub-bands used in the second communication link overlap each other, a setting is performed so that transmission power of one relay station of the two sectors can be lower than transmission power of another relay station.

5. The system according to claim 1, wherein
a setting is performed so that transmission power in the third communication link is lower than transmission power in the fourth communication link.

6. The system according to claim 1, wherein
the relay station is arranged around a midpoint of a straight line connecting two adjacent base stations.

7. A base station which belongs to a radio communication system configured to divide an assigned band into a plurality of sub-bands for use, and performs a radio communication between a mobile station and a relay station provided for each sector configured to relay a communication with the mobile station, the radio communication system in which it is preset so that a different sub-band is used for each sector for the first communication link between the base station and the relay station, and a sub-band different from the sub-band for the first communication link is used for each sector for the second communication link between the relay station and the mobile station, the base station comprising:
a radio communication interface; and
a processor configured for
detecting whether the mobile station is located in a first zone in a range at a specific distance from the base station or in a second zone farther from the base station than the first zone;
controlling the radio communication interface to use a substantially identical sub-band with the second communication link in each sector for a third communication link with the mobile station when the detecting detects that the mobile station is located in the first zone; and
controlling the radio communication interface to use a sub-band different from sub-bands of the first communication link and the second communication link for a fourth communication link between the mobile station and the base station when the detecting detects that the mobile station is located in the second zone.

8. A relay station which belongs to a radio communication system configured to divide an assigned band into a plurality of sub-bands for use, and relays a radio communication between a base station and a mobile station,
the radio communication system in which it is preset so that a difference sub-band is to be used for each sector for a first communication link between the base station and the relay station,
the relay station comprising:
a radio communication interface; and
a processor configured for
controlling the radio communication interface to use a different sub-band from the sub-band of the first communication link for each sector for the first communication link between the relay station and the mobile station; and
the sub-band is substantially identical to the sub-band used in the third communication link between the base station and the mobile station located in a first zone in a range at a specific distance from the base station, and is different from the sub-band used in the fourth communication link between the base station and the mobile station located in the second zone farther from the base station than the first zone.

9. A mobile station which belongs to a radio communication system configured to divide an assigned band into a plurality of sub-bands for use, and performs a radio communication between a base station and a relay station provided for each sector and configured to relay a communication with the base station,
the radio communication system, in which it is set in advance so that a different sub-band is to be used for each sector for a first communication link between the base station and the relay station;
the mobile station comprising:
a radio communication interface; and
a processor configured for
controlling the radio communication interface to use a sub-band different from a sub-band for the first communication link for each sector for the second communication link between the relay station and the mobile station;
controlling the radio communication interface to use a substantially identical sub-band with the second communication link for each sector for a third communication link used between the mobile station and the base station when the local mobile station is located in a first zone in a range at a specific distance from the base station; and
controlling the radio communication interface to use a different sub-band from sub-bands of the first communication link and the second communication link for a fourth communication link used between the mobile station and the base station when the mobile station is located in a second zone farther from the base station than the first zone.
